(19) United States
(12) Patent Application Publication
(10) Pub. No.: US 2009/0253507 A1
(43) Pub. Date: Oct. 8, 2009

(54) GAME MOVIE DISTRIBUTION METHOD AND SYSTEM

(75) Inventors: Takeshi ISHII, Fujisawa-shi (JP); Takehiko MIYAMOTO, Tokyo (JP); Akio ONDA, Marabi city (JP)

Correspondence Address: OLIFF & BERRIDGE, PLC, P.O. BOX 320850, ALEXANDRIA, VA, 22320-4850, US

(73) Assignee: NAMCO BANDAI GAMES INC., Tokyo (JP)

(21) Appl. No.: 12/417,951

(22) Filed: Apr. 3, 2009

(30) Foreign Application Priority Data
Apr. 4, 2008 (JP) 2008-098554

(51) Int. Cl. A63F 13/00; A63F 9/24

(52) U.S. Cl. 463/32; 463/42

(57) ABSTRACT

A game movie distribution system acquires key input information input by a player using a game device when the player plays a game. The game movie distribution system controls the movement of a character based on the key input information to reproduce the game. The game movie distribution system photographs a three-dimensional virtual space using a virtual camera that is set under a camera condition defined taking account of a view using an external terminal. The game movie distribution system generates movie data based on the photographed image, and delivers the movie data to the external terminal.

Japanese Patent Application No. 2008-98554 filed on Apr. 4, 2008, is hereby incorporated by reference in its entirety.

### BACKGROUND

A movie distribution service utilizing a communication channel (e.g., Internet) has become popular. The movie distribution service has also been applied to a game. For example, a system that receives character instruction operations input by the player, generates a game result movie based on all of the instruction operations, and then delivers the game result movie has been known (see JP-A-2003-175284, for example). According to such a system, a game image in which a number of players participate can be obtained, although the player must wait for a given time until the player can obtain the game results after inputting the instruction operations (i.e., the system lacks real-time capability).

A fighting game is a video game for which real-time capability is important. The issue of a fighting game is decided by various factors such as the timing, the type of technique, the timing at which a technique is practiced, and reflexes for techniques (i.e., the play techniques directly decide the play results). A player who prefers such a fighting game (i.e., a game in which the play techniques directly decide the play results) strongly desires to improve his or her skill, and generally desires to observe a game played between other players. It is necessary to visit a video arcade or the like in order to observe a game played between other players. However, a player who is busy with work or study can visit a video arcade only on holidays.

When distributing movie data of game play in order to deal with the above-described situation, it is likely that the movie data is delivered to a small portable terminal provided with a small display and having a limited movie display capability (e.g., a portable telephone that can browse the Internet).

### SUMMARY

According to one aspect of the invention, there is provided a game movie distribution method comprising:

acquiring key input information from a game device, the key input information being input by a player using the game device when the player plays a game;

reproducing the game played using the game device by controlling movement of a character object in a three-dimensional virtual space based on the key input information;

setting a game reproduction virtual camera in the three-dimensional virtual space and photographing the three-dimensional virtual space using the virtual camera to generate movie data for distribution, a camera condition of the virtual camera being defined taking account of a view using an external terminal; and

delivering the movie data to the external terminal.

According to another aspect of the invention, there is provided a game movie distribution system comprising:

a key input acquisition section that acquires key input information from a game device, the key input information being input by a player using the game device when the player plays a game;

a game reproduction section that reproduces the game played using the game device by controlling movement of a character object in a three-dimensional virtual space based on the key input information;

a movie data generation section that sets a game reproduction virtual camera in the three-dimensional virtual space and photographs the three-dimensional virtual space using the virtual camera to generate movie data for distribution, a camera condition of the virtual camera being defined taking account of a view using an external terminal; and

a movie distribution section that delivers the movie data to the external terminal.

### BRIEF DESCRIPTION OF THE DRAWINGS

FIG. 1 is a system configuration diagram showing a system configuration example.

FIG. 2 is a perspective external view showing a configuration example of an arcade game device.

FIG. 3 is a functional block diagram showing a functional configuration example of an arcade game device.

FIG. 4 is a view showing an example of data transmission from an arcade game device to a game server.

FIG. 5 is a functional block diagram showing a functional configuration example of a game server.

FIG. 6 is a view showing a data configuration example of a key log file.

FIG. 7 is a view showing an example of distribution standard data.

FIG. 8 is a view showing an example of play area distribution history data.

FIG. 9 is a functional block diagram showing a functional configuration example of a replay server.

FIG. 10 is a view showing an example of a distribution virtual camera setting table.

FIG. 11 is a view showing the concept of a distribution virtual camera setting with respect to a normal virtual camera setting.

FIG. 12 is a view showing an example of a thumbnail candidate selection condition.

FIG. 13 is a view showing a data configuration example of index data.

FIG. 14 is a functional block diagram showing a functional configuration example of a capture server.

FIG. 15 is a view showing a data configuration example of a movie data library.

FIG. 16 is a functional block diagram showing a functional configuration example of a movie distribution server.

FIG. 17 is a view showing an example of an image in which an advertisement is incorporated.

FIG. 18 is a view showing an example of a movie data format applicability determination table.

FIG. 19 is a view showing a data configuration example of a content library.

FIG. 20 is a functional block diagram showing a functional configuration example of a movie conversion server.

FIG. 21 is a flowchart illustrative of the flow of a process of a system.

FIG. 22 is a flowchart illustrative of the flow of a process of a system.

FIG. 23 is a flowchart illustrative of the flow of a process of a system.

FIG. 24 is a flowchart illustrative of the flow of a content library management process.

FIG. 25 is a view showing a configuration example of a movie distribution website.

FIG. 26 is a system configuration diagram showing a modification of a game movie distribution system.

FIG. 27 is a functional block diagram showing a functional configuration example according to a modification of a game movie distribution system.

FIG. 28 is a view showing an example of RPG distribution virtual camera setting data.

### DESCRIPTION OF EXEMPLARY EMBODIMENTS

The invention may implement movie distribution that enables a user to easily observe a game played between other players by utilizing a small terminal that can utilize a movie distribution service without visiting a place (e.g., video arcade) where the game is played.

According to one embodiment of the invention, there is provided a game movie distribution method comprising:

acquiring key input information from a game device, the key input information being input by a player using the game device when the player plays a game;

reproducing the game played using the game device by controlling movement of a character object in a three-dimensional virtual space based on the key input information;

setting a game reproduction virtual camera in the three-dimensional virtual space and photographing the three-dimensional virtual space using the virtual camera to generate movie data for distribution, a camera condition of the virtual camera being defined taking account of a view using an external terminal; and

delivering the movie data to the external terminal.

According to another embodiment of the invention, there is provided a game movie distribution system comprising:

a key input acquisition section that acquires key input information from a game device, the key input information being input by a player using the game device when the player plays a game;

a game reproduction section that reproduces the game played using the game device by controlling movement of a character object in a three-dimensional virtual space based on the key input information;

a movie data generation section that sets a game reproduction virtual camera in the three-dimensional virtual space and photographs the three-dimensional virtual space using the virtual camera to generate movie data for distribution, a camera condition of the virtual camera being defined taking account of a view using an external terminal; and

a movie distribution section that delivers the movie data to the external terminal.

The term “key input information” used herein refers to information used to identify an operation input performed using an operation input device such as a lever (e.g., joystick), a button switch (e.g., arrow key), an acceleration sensor, or a tilt sensor. For example, an operation code and the like correspond to the key input information. Note that other types of information may also be used insofar as an operation input can be identified.

According to this embodiment, the key input information is acquired from the game device used for playing the game in the actual store (e.g., video arcade). The game play is reproduced based on the key input information, and the process of the game play is delivered to the external terminal as movie data. In this case, the movie data is generated based on the image of the three-dimensional virtual space photographed under the virtual camera setting condition aimed at a limited display capability such as that of a small terminal or the like. Therefore, movie data with high visibility can be delivered even when delivering a movie to a terminal having a limited resolution and display size. Therefore, a high visual quality can be implemented.

The game movie distribution method may further comprise:

acquiring specification information that relates to a movie reproduction capability from the external terminal, the specification information including at least an aspect ratio; and

setting an angle of view of the virtual camera based on the specification information.

The game movie distribution method may further comprise:

setting a focus point in the three-dimensional virtual space based on a position of the character object in the three-dimensional virtual space; and

controlling a position of the virtual camera so that a line-of-sight direction of the virtual camera aims at the focus point.

The game movie distribution method may further comprise:

setting a virtual damper function that serves as resistance against a change in position of the virtual camera.

According to this configuration, since a change in movement of the virtual camera is reduced by the damper function, a change in screen is reduced. Therefore, movie data that can be easily observed even on a small screen of a portable terminal can be generated. Moreover, block noise can be suppressed when decoding the movie data.

The game movie distribution method may further comprise:

setting a focus point in the three-dimensional virtual space based on a position of the character object in the three-dimensional virtual space; and

controlling rotation of the virtual camera so that a line-of-sight direction of the virtual camera aims at the focus point.

The game movie distribution method may further comprise:

setting a virtual damper function that serves as resistance against a change in direction of the virtual camera.

According to this configuration, since a change in direction of the virtual camera is reduced by the damper function, a change in screen is reduced. Therefore, movie data that can be easily observed even on a small screen of a portable terminal can be generated. Moreover, block noise can be suppressed when decoding the movie data.

Embodiments to which the invention is applied are described below taking an example of a movie data generation system/game movie distribution system that generates and distributes movie data of match play using a plurality of server devices in order to distribute a movie of a fighting game played using an arcade game device.

System Configuration

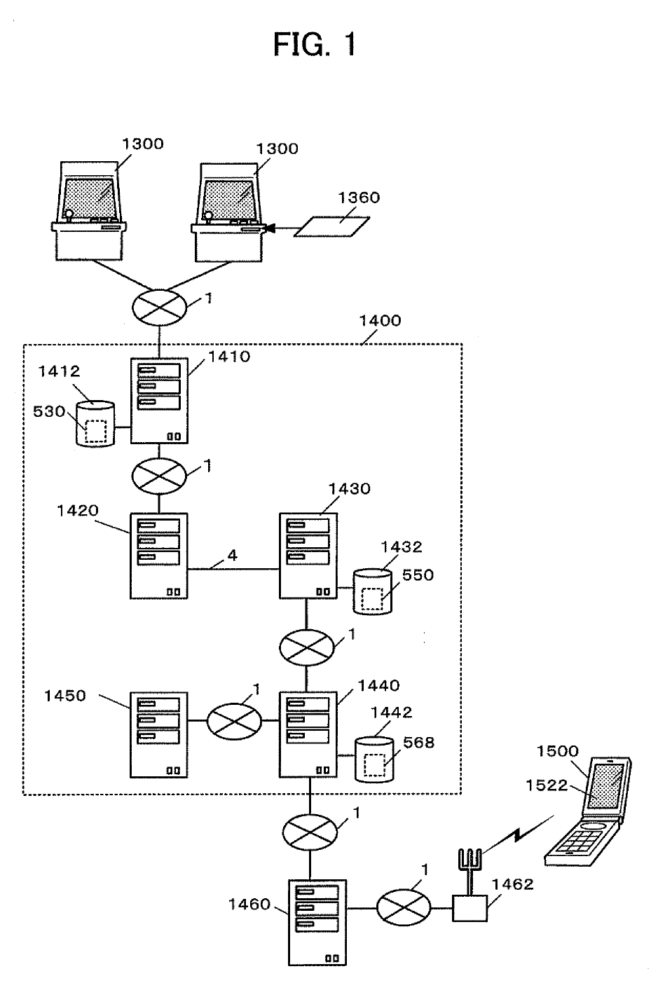

FIG. 1 is a system configuration diagram showing a system configuration example according to one embodiment of the invention. A game movie distribution system 1400 according to this embodiment includes a game server 1410, a replay server 1420, a capture server 1430, a movie distribution server 1440, and a movie conversion server 1450. These servers cooperate to generate movie data and distribute a movie utilizing communication channels 1 (e.g., Internet, local network, leased line network, another network, and a router that relays communications) in response to a request transmitted from a portable terminal 1500 (external terminal) that can browse a website through the communication channels 1. Each communication channel is indicated by reference numeral 1 in the drawings and the description for convenience. Note that a communication network corresponding to each communication mode is provided. The portable terminal 1500 may be an information processing device such as a portable telephone, an ultra-mobile personal computer (UMPC), a portable game device, or a personal digital assistant (PDA).

An arcade game device 1300 used to play the fighting game is classified as a game device that enables an online match game, and transmits an operation code that indicates an operation input to another (opposing) arcade game device 1300 (opposing device) in a given cycle through the communication channel 1. The arcade game device 1300 controls the movement of characters in a game space created in the arcade game device 1300 based on the operation code generated in the arcade game device 1300 and the operation code received from the opposing device to implement the fighting game. The arcade game devices 1300 generally communicate through a local network provided in the store instead of the Internet. This is because a high transmission rate and a high communication capability are required. Since the issue of the fighting game is decided based on the difference in operation input in a very short time, the arcade game device 1300 performs high-speed processing. Therefore, a transmission rate that can deal with high-speed processing is required.

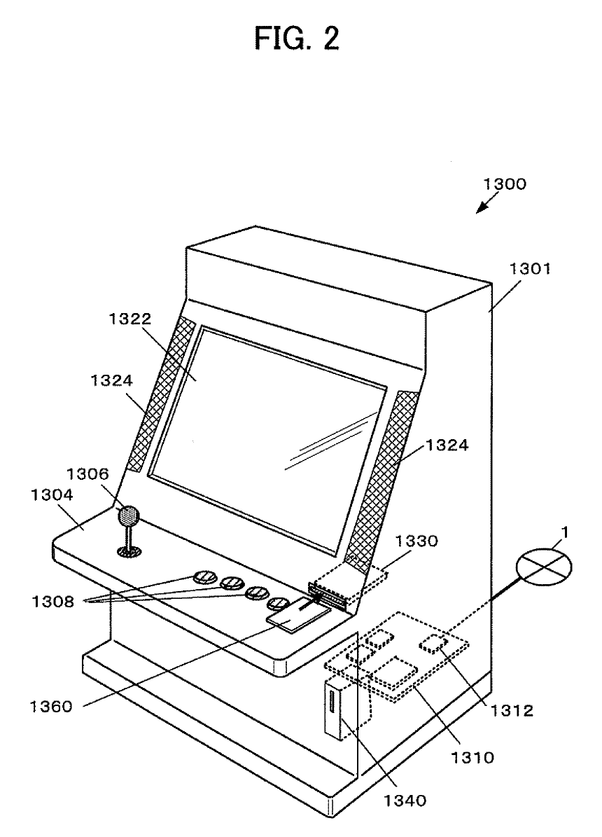

As shown in FIG. 2, the arcade game device 1300 includes a game device main body 1301, (1) a console 1304 provided with input devices such as a joystick 1306 and a plurality of push switches 1308 for the player to perform an operation input, (2) an image display device 1322 (e.g., liquid crystal display or CRT) that displays a game image, (3) a speaker 1324, a game card reader/writer 1330 that read/writes data from/into a game card 1360 (i.e., portable information storage medium), (4) a coin counter 1340, (5) a control unit 1310, and a power supply device (not shown), for example.

The control unit 1310 includes electric/electronic instruments such as various processors (e.g., central processing unit (CPU), graphics processing unit (GPU), and digital signal processor (DSP)), an application-specific integrated circuit (ASIC), and an IC memory. The control unit 1310 includes a communication device 1312 that connects to the communication line 1 (e.g., Internet, local area network (LAN), or wide area network (WAN)), and implements data communication with an external device (particularly another arcade game device 1300 and the game server 1410). The control unit 1310 reads a system program and a game program stored in a storage device (e.g., IC memory), and performs calculations to control each section of the arcade game device 1300.

When the player desires to play the fighting game using the arcade game device 1300 according to this embodiment, the player must register himself and obtain a game card 1360 that stores player information (e.g., handle name and the type of character used) in the same manner as a known online arcade game device. When the player plays the fighting game, the player inserts the game card 1360 into the game card reader/writer 1330 of the arcade game device 1300 so that the game card reader/writer 1330 reads the player information stored in the game card 1360. A dedicated registration device that is separately provided or the arcade game device 1300 may accept player registration and issue the game card 1360. Note that the game server 1410 stores and manages the player registration information.

When the coin counter 1340 has detected that the player has inserted coins corresponding to a given amount, the control unit 1310 reads and executes the game program. When the control unit 1310 starts the game, the control unit 1310 reads the player information from the player's game card 1360 through the game card reader/writer 1330, and selects a character used in the game. The control unit 1310 transmits an operation code based on an operation input performed using the joystick 1306 and the push switch 1308 to the opposing device (i.e., the arcade game device 1300 operated by the opposing player) in a given cycle, and receives an operation code transmitted from the opposing device.

The control unit 1310 controls the movement of a character object and the like in the game space formed in a three-dimensional space based on the operation code received from the opposing device and the operation code based on an operation input performed by the player. The control unit 1310 photographs the game space using a virtual camera to generate a game screen (image), and generates game sound (e.g., background music (BGM) and effect sound) at an appropriate timing. The game screen generated by the control unit 1310 is displayed on the image display device 1322, and the game sound generated by the control unit 1310 is output from the speaker 1324. The player plays the game while watching the game screen displayed on the image display device 1322 and listening to the game sound output from the speaker 1324.

The arcade game device 1300 successively transmits the operation code based on an operation input to the game server 1410 during the game in a given cycle in the same manner as successive transmission of the operation code to the opposing device during the game play.

The game server 1410 is a server device that executes server application software, and includes a storage 1412 (e.g., hard disk) as a storage area (see FIG. 1).

In this embodiment, the game server 1410 performs a player information registration/management process, registers a pair of arcade game devices 1300 used for match play, and stores and registers the operation codes transmitted from the arcade game devices 1300 during the game in a key log file library 530 stored (formed) in the storage 1412 as key log data corresponding to each game play. The game server 1410 selects the key log data stored in the key log file library 530 after completion of the match game based on a given distribution standard, and transmits the key log data determined to be appropriate for distribution to the replay server 1420 together with the player information relating to the two players who have played the match game and the like through the communication channel 1.

The replay server 1420 is a server device that includes a processing section similar to the control unit 1310 of the arcade game device 1300 and executes server application software. The replay server 1420 reproduces the game play implemented by the arcade game device 1300 according to the key log data received from the game server 1410, and outputs the game image and the game sound during reproduction to the capture server 1430 via a cable 4.

The capture server 1430 is a server device that has a movie capture function. The capture server 1430 captures the game image and the game sound output from the replay server 1420, generates movie data in a given movie data format (synonymous with a movie format and a video format), and stores and registers the movie data in a movie data library 550 stored in a storage 1432.

The replay server 1420 stores a frame number of the movie counted from the start of the game play at a timing when the state of the game being reproduction satisfies a given thumbnail image selection condition. The replay server 1420 selects one frame number from the stored frame numbers, reads a specific scene from the corresponding movie data based on the selected frame number to generate a thumbnail image in a given format, and transmits the thumbnail image to the capture server 1430. The capture server 1430 incorporates the thumbnail image received from the replay server 1420 in the movie data that has been generated by the capture server 1430.

The capture server 1430 stores a plurality of pieces of movie data thus generated in the movie data library 550 stored in the storage 1432. In this embodiment, the movie data registered in the movie data library 550 is the original data that is delivered to the portable terminal 1500. The capture server 1430 automatically performs a management process that deletes the movie data that has been registered for a given period of time (e.g., 14 days; the given period of time can be appropriately set corresponding to the storage capacity of the storage 1432), updates movie data library list data, and supplies the movie data library list data to the movie distribution server 1440.

The movie distribution server 1440 is a server device that stores and manages site information relating to a movie distribution website. The movie distribution server 1440 acquires the movie data library list data from the capture server 1430, and automatically updates the site information so that the movie data registered in the movie data library list data is posted in the movie distribution website. The movie distribution server 1440 controls distribution (delivery) of the movie requested by the portable terminal 1500 that has accessed the movie distribution website in the same manner as a known movie distribution website.

The movie data delivered to the portable terminal 1500 is stored in a content library 568 stored in a storage 1442. In this embodiment, when the movie data requested by the portable terminal 1500 is not stored in the content library 568, the movie distribution server 1440 requests the capture server 1430 to transmit the corresponding movie data, incorporates given advertisement data in the received movie data, delivers the movie data to the portable terminal 1500, and adds the movie data to the content library 568.

The movie distribution server 1440 acquires movie reproduction capability specification information or information necessary for determining the movie reproduction capability (e.g., model information) from the portable terminal 1500 before the movie distribution server 1440 delivers the movie data, and determines whether or not the movie data format of the movie data requested by the portable terminal 1500 is appropriate for the movie display capability of the portable terminal 1500. When the movie distribution server 1440 has determined that the movie data format of the movie data is not appropriate for the movie display capability of the portable terminal 1500, the movie distribution server 1440 acquires the movie data requested by the portable terminal 1500 from the capture server 1430 (reads the movie data from the content library 568), and transmits the movie data to the movie conversion server 1450 so that the movie conversion server 1450 converts the movie data format into a movie data format appropriate for the movie display capability of the portable terminal 1500. The movie distribution server 1440 receives the converted movie data, incorporates the advertisement data in the received movie data, delivers the movie data to the portable terminal 1500, and adds the movie data to the content library 568. Since the movie data that has been delivered is stored in the content library 568, the movie distribution server 1440 deals with a request for the same movie data in the same movie data format by reading the movie data from the content library 568 and delivering the movie data.

The movie data is delivered from the movie distribution server 1440 to the portable terminal 1500 through a communication carrier server 1460 and a base station 1462 managed by a communication carrier in the same manner as in a known movie distribution service. The portable terminal 1500 decodes the movie data delivered from the movie distribution server 1440 using a built-in computer, and reproduces (displays) the movie on an image display device 1522.

Functional Configuration of Arcade Game Device

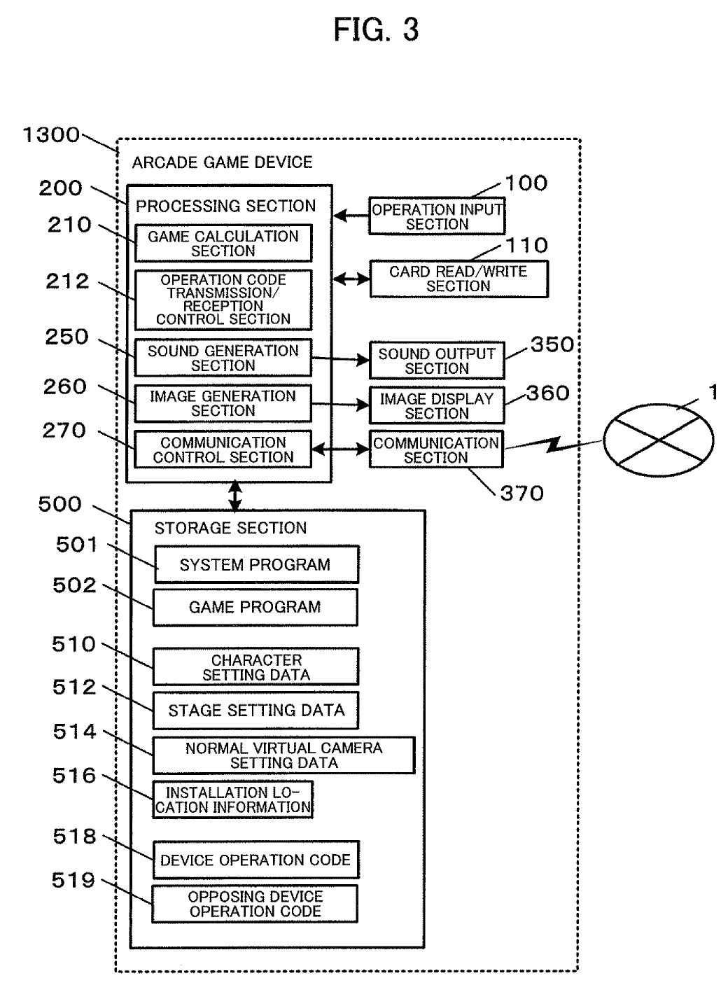

FIG. 3 is a functional block diagram showing a functional configuration example of the arcade game device 1300 according to this embodiment. The arcade game device 1300 includes an operation input section 100, a card read/write section 110, a processing section 200, a sound output section 350, an image display section 360, a communication section 370, and a storage section 500.

The operation input section 100 is implemented by an input device and a sensor such as a push button, a lever, a touch pad, a dial, a keyboard, a mouse, a pointer, an acceleration sensor, or a tilt sensor. The operation input section 100 outputs an operation input signal or an operation code to the processing section 200 corresponding to an operation input performed by the player. The joystick 1306 and the push button 1308 shown in FIG. 2 correspond to the operation input section 100.

The card read/write section 110 is a device that can read data from the game card 1360 (i.e., portable information storage medium) or write data into the game card 1360 under control of the processing section 200. For example, the card read/write section 110 is implemented by a magnetic card reader/writer when the game card 1360 is a magnetic card, and is implemented by an IC card reader/writer when the game card 1360 is an IC card. The game card reader/writer 1330 shown in FIG. 2 corresponds to the card read/write section 110.

The processing section 200 is implemented by electronic components such as a microprocessor, an image drawing processor, an application-specific integrated circuit (ASIC), and an IC memory. The processing section 200 exchanges data with each functional section, and controls the operation of the arcade game device 1300 by performing various calculation processes based on a given program, data, and the operation input signal from the operation input section 100. In FIG. 2, the control unit 1310 provided in the game device main body 1301 corresponds to the processing section 200. The processing section 200 according to this embodiment includes a game calculation section 210, an operation code transmission/reception control section 212, a sound generation section 250, an image generation section 260, and a communication control section 270.

The game calculation section 210 performs a process that proceeds with the fighting game. For example, the game calculation section 210 performs (1) a process that forms the game space (e.g., a stage in which the characters fight) in the three-dimensional virtual space, (2) a process that controls placement of the object (e.g., character) disposed in the game space, (3) a process that controls the movement of the characters based on the operation code based on an operation input performed using the operation input section 100 and the operation code acquired from the arcade game device 1300 of the opposing player, (4) a process that displays effects when a given condition has been satisfied, (5) a process that determines a hit and damage of an offensive technique, (6) a physical calculation process, (7) a process that determines the game results, and the like.

The operation code transmission/reception control section 212 transmits the operation code that indicates the input device of the operation input section 100 that has been operated by the player to the opposing device through the communication control section 270 and the communication section 370 in a given cycle (e.g., a cycle equal to or shorter than the drawing rate of the image display section 360), and receives the operation code transmitted from the opposing device.

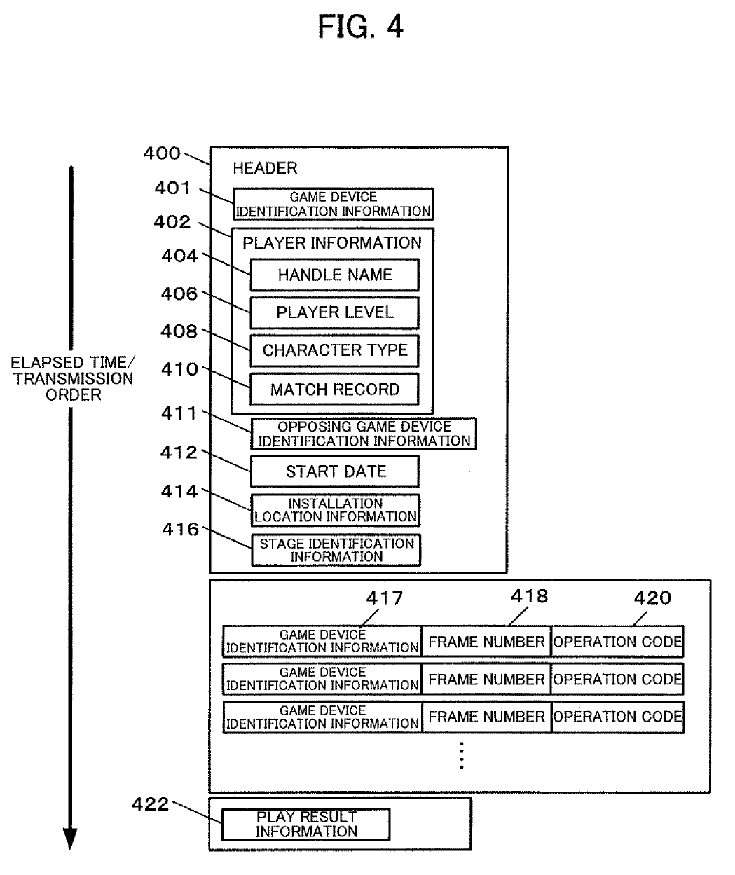

The operation code transmission/reception control section 212 transmits the operation code of the arcade game device 1300 to the game server 1410 in a given cycle. As shown in FIG. 4, the operation code transmission/reception control section 212 transmits game device identification information 401 (e.g., IP address) that identifies the arcade game device 1300 in the Internet space, player information 402 read from the game card 1360 using the card read/write section 110, opposing game device identification information 411, a match play start date 412, device installation location information 414 stored in the storage device 500 in advance, and stage identification information 416 that indicates the game stage selected by the player when starting the game as a header 400 before the game starts. The player information 402 includes a handle name 404, a player level 406, a character type 408, and a match record 410 (e.g., total win-loss record and consecutive victory record), for example.

After the operation code transmission/reception control section 212 has transmitted the header 400, the operation code transmission/reception control section 212 successively transmits an operation code 420 based on an operation input to the game server 1410 in a given cycle during the game while associating the operation code 420 with game device identification information 417 and a frame number 418 that is counted from the start of the game. When the game ends, the operation code transmission/reception control section 212 transmits play result information 422 that indicates the player who has won the game, the consecutive victory record of the player who has won the game, and the like.

The sound generation section 250 is implemented by a processor such as a digital signal processor (DSP) and its control program, for example. The sound generation section 250 generates a sound signal of game-related effect sound, background music (BGM), or operation sound based on the processing results of the game calculation section 210, and outputs the generated sound signal to the sound output section 350.

The sound output section 350 is implemented by a device that outputs sound such as effect sound or BGM based on the sound signal input from the sound generation section 250. In FIG. 2, the speaker 1324 corresponds to the sound output section 350.

The image generation section 260 is implemented by a processor such as a digital signal processor (DSP), its control program, a drawing frame IC memory such as a frame buffer, and the like. For example, the image generation section 260 generates a game image every frame time ( 1/60 sec) based on the processing results of the game calculation section 210, and outputs image signals of the generated game image to the image display section 360.

The image display section 360 displays various game images based on the image signals input from the image generation section 260. The image display section 360 may be implemented by an image display device such as a flat panel display, a cathode-ray tube (CRT), a projector, or a head mount display. In FIG. 2, the image display device 1322 corresponds to the image display section 360.

The communication control section 270 performs data processing relating to data communications to exchange data with an external device via the communication section 370.

The communication section 370 connects to the communication line 1 to implement communication. The communication section 370 is implemented by a transceiver, a modem, a terminal adapter (TA), a jack for a communication cable, a control circuit, and the like. In FIG. 2, the communication device 1312 corresponds to the communication section 370.

The storage section 500 stores a predetermined program and data, and is used as a work area for the processing section 200. The storage section 500 temporarily stores the results of calculations performed by the processing section 200 according to various programs, input data input from the operation section 100, and the like. The function of the storage section 500 is implemented by an IC memory (e.g., RAM or ROM), a magnetic disk (e.g., hard disk), an optical disk (e.g., CD-ROM or DVD), or the like.

The storage section 500 according to this embodiment stores a system program 501 that implements a function of causing the processing section 200 to control the arcade game device 1300, a game program 502 that causes the processing section 200 to execute the fighting game, various types of data, and the like. The functions of the game calculation section 210 and the operation code transmission/reception control section 212 may be implemented by the processing section 200 by causing the processing section 200 to read and execute the game program 502.

The storage section 500 also stores character setting data 510, stage setting data 512, normal virtual camera setting data 514, and installation location information 516 as data provided in advance. A device operation code 518 in which the operation code based on an operation input performed by the player is temporarily stored, and an opposing device operation code 519 in which the operation code received from the opposing device is temporarily stored, are also stored in the storage section 500 as data that is generated with the progress of the game and is rewritten at any time. The storage section 500 also stores virtual camera control data (e.g., angle of view, line-of-sight direction, and position information), time limit count data, and the like as information necessary for proceeding with the game.

Basic information necessary for displaying the character used in the match game and controlling the movement of the character (e.g., model data, texture data, and motion data of the character) is stored as the character setting data 510 corresponding to each character.

Information (e.g., model data and texture data) used to form a fighting stage in the three-dimensional virtual space is stored as the stage setting data 512 corresponding to each stage.

Normal settings of the virtual camera that photographs the game space are stored as the normal virtual camera setting data 514. For example, the position, the angle of view, the moving path, the moving speed, the rotational direction, the rotational speed, and a change in zoom of the virtual camera are set as the normal virtual camera setting data 514.

Information relating to the installation location of the arcade game device 1300 is stored as the installation location information 516. For example, the administrative division, municipality, store name, and the like may be set as the installation location information 516 when the arcade game device 1300 is used in Japan.

Functional Configuration of Game Server

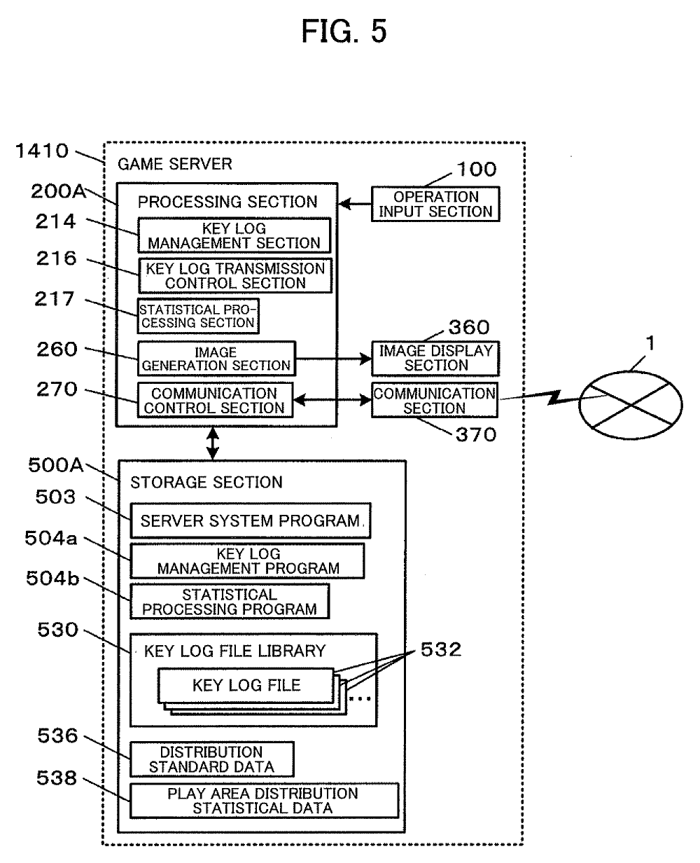

FIG. 5 is a functional block diagram showing a functional configuration example of the game server 1410 according to this embodiment. Note that the functional blocks identical to those of the arcade game device 1300 are indicated by the same reference numerals. Detailed description of these functional blocks is omitted.

The game server 1410 includes an operation input section 100 that allows the operator to perform an operation input when managing the game server 1410, a processing section 200A, an image display section 360 that displays an operation screen when managing the game server 1410, a communication section 370, and a storage section 500A.

The processing section 200A of the game server 1410 is implemented by electronic components such as a microprocessor, an image drawing processor, an application-specific integrated circuit (ASIC), and an IC memory. The processing section 200A exchanges data with each functional section, and controls the operation of the game server 1410 by performing various calculation processes based on a given program, data, and the operation input signal from the operation input section 100.

The storage section 500A of the game server 1410 stores a predetermined program and data, and is used as a work area for the processing section 200A. The storage section 500A temporarily stores the results of calculations performed by the processing section 200A according to various programs, for example. The function of the storage section 500A is implemented by an IC memory (e.g., RAM or ROM), a magnetic disk (e.g., hard disk), an optical disk (e.g., CD-ROM or DVD), or the like.

In this embodiment, the processing section 200A includes a key log management section 214, a key log transmission control section 216, and a statistical processing section 217.

The key log management section 214 collects the header 400, the frame number 418, the operation code 420, and the like received from each of the two arcade game devices 1300 corresponding to each game play to generate a key log file 532, and stores and registers the key log file 532 in the key log file library 530 stored in the storage section 500. The key log management section 214 performs a management process that automatically deletes the key log file 532 that has been registered over a given period of time.

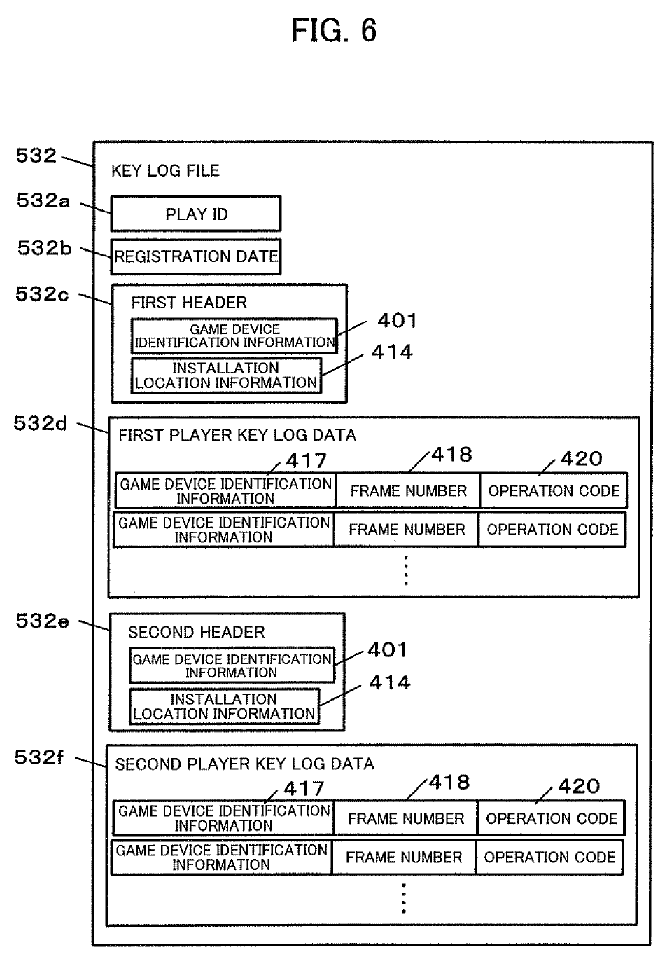

As shown in FIG. 6, the key log file 532 includes (1) a play ID 532a that is a sequential number allocated by the key log management section 214 in the order of generation, (2) a registration date 532b, (3) a first header 532c that corresponds to the header 400 received from one of the two arcade game devices 1300, (4) a first player key log data 532d that stores the game device identification information 417, the frame number 418, and the operation code 420 received from one of the two arcade game devices 1300 in time series, (5) a second header 532e that corresponds to the header 400 received from the other arcade game device 1300, and (6) a second player key log data 532f that stores the game device identification information 417, the frame number 418, and the operation code 420 received from the other arcade game devices 1300 in time series, for example.

The key log transmission control section 216 causes the key log file 532 that satisfies a given distribution standard to be transmitted to the replay server 1420 through the communication control section 270 and the communication section 370 referring to distribution standard data 536 stored in the storage section 500A.

The statistical processing section 217 performs given statistical calculations on the number of games that have been reproduced corresponding to each installation location of the arcade game device 1300 that has executed the game reproduced by the replay server 1420. In this embodiment, the statistical processing section 217 takes statistics corresponding to each area based on the installation location information 414 that corresponds to the key log file 532 that satisfies the standard indicated by the distribution standard data 536 and is determined to be the distribution target at a probability corresponding to each standard, and stores the results in the storage section 500A as play area distribution statistical data 538.

The storage section 500A of the game server 1410 includes the storage 1412 shown in FIG. 1. The storage section 500A stores a server system program 503, a key log management program 504a that causes the processing section 200A to function as the key log management section 214, a statistical processing program 504b that causes the processing section 200A to function as the statistical processing section 217, the key log file library 530, the distribution standard data 536, and the play area distribution statistical data 538.

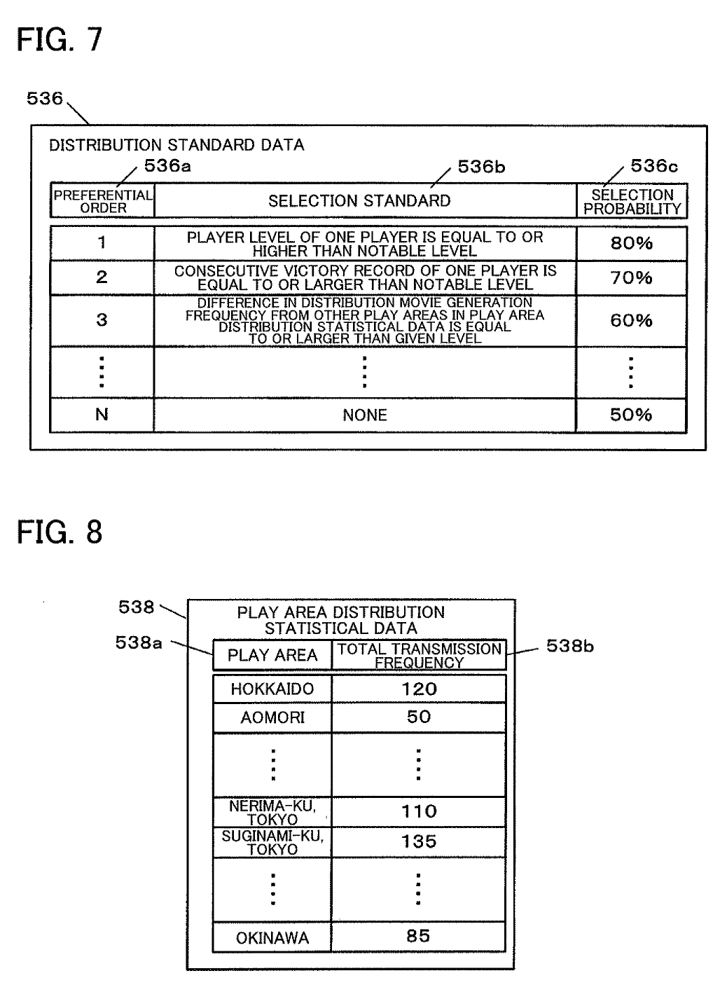

As shown in FIG. 7, a selection standard 536b and a selection probability 536c that defines the selection probability when the selection standard is satisfied are stored as the distribution standard data 536 corresponding to a preferential order 536a, for example. The key log transmission control section 216 determines whether or not the target key log file 532 satisfies the selection standard 536b corresponding to the preferential order 536a. When the key log transmission control section 216 has determined that the target key log file 532 satisfies the selection standard 536b, the key log transmission control section 216 determines whether or not to select the key log file 532 at the probability set as the selection probability 536c. When the key log transmission control section 216 has determined to select the key log file 532, the key log transmission control section 216 causes the key log file 532 to be transmitted to the replay server 1420.

The selection standard 536b defines information used to determine whether or not to determine the key log file 532 to be a distribution candidate based on the information included in the header 400 and the play result information 422 (see FIG. 4).

When the game is the fighting game as in this embodiment, for example, a condition “the player level of one player is equal to or higher than a given level”, a condition “the consecutive victory record of one player is equal to or larger than a given level”, and the like may be set as the selection standard.

When it is desired to promote communications between players who make a living in the same area by distributing a match play movie from the movie distribution website, it is not desirable that the location where the match play of the movie to be distributed has been performed is biased. Therefore, a condition “the difference in distribution movie generation frequency from other play areas in the play area distribution statistical data is equal to or larger than a given level” may be included in the selection standard 536b. Specifically, the deviation value of the distribution movie generation frequency is calculated corresponding to each area, and an area having a deviation value of less than 40 is selected, for example. In this embodiment, the play area distribution statistical data 538 is stored in the storage section 500A of the game server 1410 in order to determine whether or not the condition is satisfied.

The key log transmission control section 216 stores statistical information relating to the location where the game play indicated by the key log file 532 transmitted to the replay server 1420 was performed (i.e., the installation location of the arcade game device 1300) as the play area distribution statistical data 538.

As shown in FIG. 8, the key log transmission control section 216 stores a key log file transmission frequency 538b (i.e., the total number of times that the key log file has been transmitted) corresponding to a play area 538a (i.e., the location where the game play was performed), for example.

Functional Configuration of Replay Server

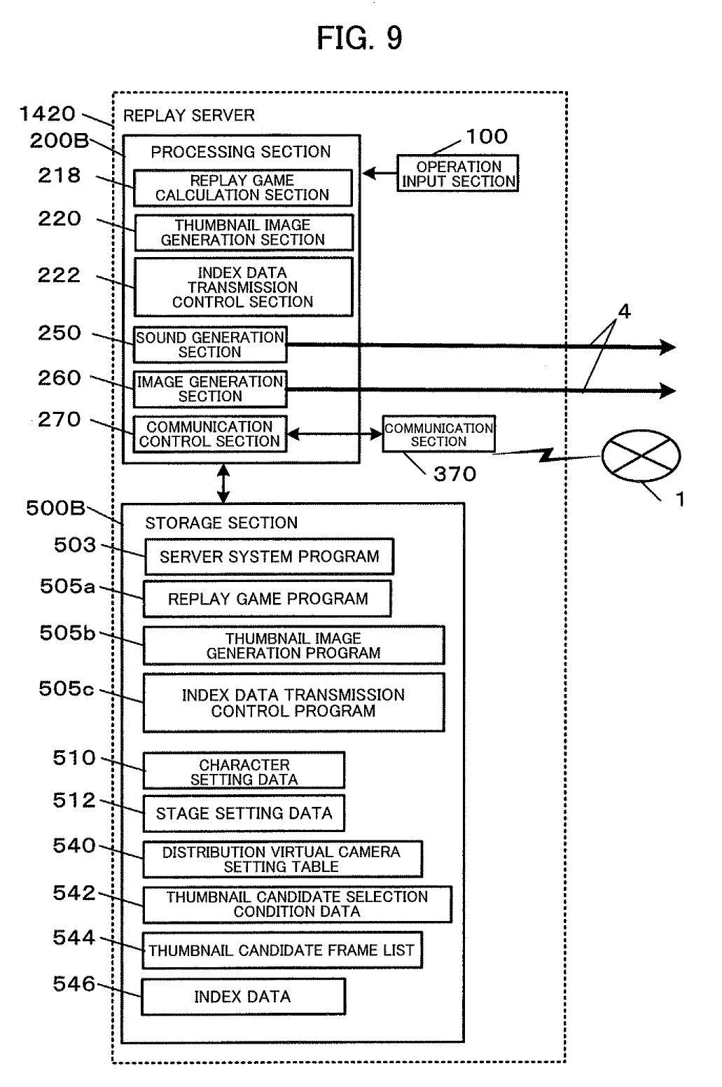

FIG. 9 is a functional block diagram showing a functional configuration example of the replay server 1420 according to this embodiment. Note that the functional blocks identical to those of the arcade game device 1300 and the game server 1410 are indicated by the same reference numerals. Detailed description of these functional blocks is omitted.

The replay server 1420 is a device that reproduces game play based on historical information (key log file 532) that indicates operation inputs that have been performed during one play and acquired from an external device.

The replay server 1420 includes an operation input section 100 that allows the operator to perform an operation input when managing the replay server 1420, a processing section 200B, a communication section 370, and a storage section 500B.

The processing section 200B of the replay server 1420 is implemented by electronic components such as a microprocessor, an image drawing processor, an application-specific integrated circuit (ASIC), and an IC memory. The processing section 200B exchanges data with each functional section, and controls the operation of the replay server 1420 by performing various calculation processes based on a given program, data, and the operation input signal from the operation input section 100.

The storage section 500B of the replay server 1420 stores a predetermined program and data, and is used as a work area for the processing section 200B. The storage section 500B temporarily stores the results of calculations performed by the processing section 200B according to various programs, for example. The function of the storage section 500B is implemented by an IC memory (e.g., RAM or ROM), a magnetic disk (e.g., hard disk), an optical disk (e.g., CD-ROM or DVD), or the like.

In this embodiment, the processing section 200B of the replay server 1420 includes a replay game calculation section 218 that corresponds to the game calculation section 210 of the arcade game device 1300, a thumbnail image generation section 220, and an index data transmission control section 222.

The replay game calculation section 218 basically has the same functions as those of the game calculation section 210. However, the replay game calculation section 218 executes the game process based on the operation code stored in the received key log file 532 instead of an operation input performed using the operation input section 100.

The replay game calculation section 218 controls the game process utilizing the virtual camera setting defined by distribution virtual camera setting data 540 that is set separately from the normal virtual camera setting data 516 applied to the arcade game device 1300.

When the state of the game play being reproduction satisfies a given movie data thumbnail image candidate condition (thumbnail candidate selection condition data 542), the thumbnail image generation section 220 sequentially registers the frame number of the movie at that timing in a thumbnail candidate frame list 544 stored in the storage section 500B. The thumbnail image generation section 220 selects one frame number from the frame numbers registered in the thumbnail candidate frame list 544 after the game ends, and generates an image corresponding to the selected frame number to generate a thumbnail image in a given format.

The index data transmission control section 222 generates index data 546 that includes information that indicates the movie including the thumbnail image generated by the thumbnail image generation section 220, and causes the index data 546 to be transmitted to the capture server 1440 through the communication control section 270 and the communication section 370.

The storage section 500B of the replay server 1420 stores a server system program 503, a replay game program 505a that causes the processing section 200B to function as the replay game calculation section 218, a thumbnail image generation program 505b that causes the processing section 200B to function as the thumbnail image generation section 220, and an index data transmission control program 505c that causes the processing section 200B to function as the index data transmission control section 222.

The storage section 500B of the replay server 1420 also stores the character setting data 510 and the stage setting data 512 identical to those stored in the arcade game device 1300, the distribution virtual camera setting table 540 that replaces the normal virtual camera setting data 514, and the thumbnail candidate selection condition data 542. The thumbnail candidate frame list 544 and the index data 546 that are appropriately generated are also stored in the storage section 500B of the replay server 1420.

The distribution virtual camera setting table 540 stores the virtual camera setting that is set taking account of the visibility of the movie reproduced in the portable terminal 1500 taking account of the limited display size and resolution of the portable terminal 1500, noise specific to the movie data that is compressed for distribution, and the like.

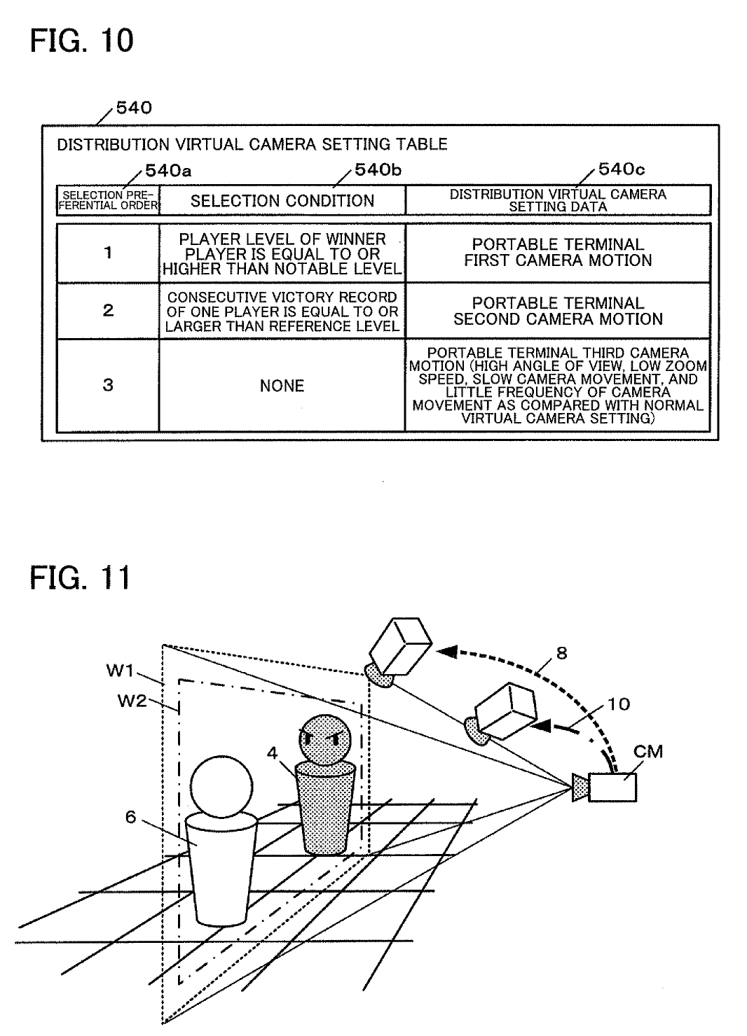

As shown in FIG. 10, a selection condition 540b and distribution virtual camera setting data 540c are stored in the distribution virtual camera setting table 540 corresponding to a selection preferential order 540a, for example. The replay game calculation section 218 determines whether or not the selection condition 540b corresponding to the selection preferential order 540a is satisfied. When the replay game calculation section 218 has determined that the selection condition 540b is satisfied, the replay game calculation section 218 reads the corresponding distribution virtual camera setting data 540c, and controls the virtual camera according to the setting defined by the distribution virtual camera setting data 540c.

In this embodiment, whether or not the selection condition 540b is satisfied can be determined based on the information included in the first header 532c and the second header 532e of the key log file 532 transmitted from the game server 1410 (see FIG. 6).

As schematically shown in FIG. 11, the angle of view (or position) of the virtual camera is set so that a photographing range W2 when the virtual camera CM that photographs opposing characters 4 and 6 is positioned at the greatest distance from the characters 4 and 6, is smaller than a photographing range W1 set based on the normal virtual camera setting data 516 applied to the arcade game device 1300. Specifically, the characters 4 and 6 are displayed to occupy a large area of the screen. The number of movements, the moving distance, the moving speed, a change in zoom, the rotation, and the like of the virtual camera CM are set to be smaller than those of the normal virtual camera setting data 514 (a line 8 indicates the normal setting, and a line 10 indicates the distribution setting).

Since the replay game calculation section 218 controls the virtual camera according to the above-mentioned setting, the characters 4 and 6 are displayed to occupy a large area of the screen while suppressing a block noise pattern even if the movie data created from the reproduced game screen is reduced in drawing frame rate, reduced in display size, or compressed. Therefore, the movement of the character can be easily observed on the image display device 1522 of the portable terminal 1500 that is small and has a small number of pixels.

In this embodiment, it is desirable that the virtual camera mainly photograph the character of the player who wins the match (i.e., the viewpoint of the virtual camera is directed to the character of the player who wins the match) in the distribution virtual camera setting corresponding to the condition “player level of winner player is equal to or higher than given level” or the condition “consecutive victory record of one player is equal to or larger than reference level” set as the selection condition 540b.

The thumbnail candidate selection condition data 542 is information that defines a game state condition used to select a candidate for the thumbnail image. A condition that selects a characteristic screen or an impressive screen in the game play is defined as the thumbnail candidate selection condition data 542.

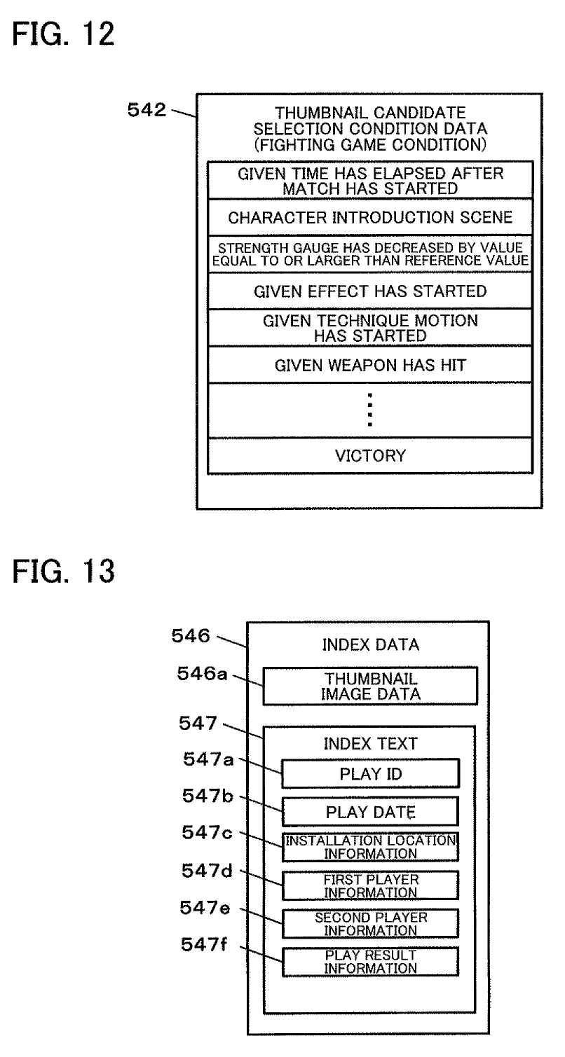

When the game is the fighting game as in this embodiment, for example, it is desirable that the thumbnail candidate selection condition data 542 be set as shown in FIG. 12. Whether or not a condition “a given time has elapsed after the match has started” is satisfied can be determined based on the time elapsed after the game has started. In this case, since a player generally aims at carrying out a preemptive strike at a timing when a given time (e.g., 2 to 5 seconds) has elapsed after the game has started, a scene in which the character performs a technique can be selected.

Whether or not a condition “character introduction scene” is satisfied can be determined based on whether or not a background image for the introduction scene has been selected. In this case, an image in which the characters are displayed to face each other can be selected. When the fighting game is designed so that the player can customize the design of the character, the character that appears in the game can be easily determined by the thumbnail image.

Whether or not a condition “the strength gauge has decreased by a value equal to or larger than a reference value” is satisfied can be determined by monitoring a change in parameter of the strength gauge. In this case, an image of a scene in which the character is severely hurt or a scene in which the character is flung away can be selected.

Whether or not a condition “a given effect has started” or “given technique motion has started” is satisfied can be determined by referring to a flag of the given effect or motion identification information. In this case, since an image in which the character carries out a given technique can be selected, an attractive thumbnail image can be created.

Whether or not a condition “a given weapon has hit” is satisfied can be determined based on whether or not the object of a given weapon used by the character has hit the object of the opposing character. In this case, an impressive image in which the character attacks the opposing character using a weapon can be selected. The hit determination target may be the opposing character, a weapon, a protector, an extra character (e.g., obstacle or audience), or the like. The hit determination target may be appropriately set corresponding to the game.

Whether or not a condition “victory” is satisfied can be determined based on whether or not a victory motion (victory determination flag) set corresponding to each character is performed.

The selection condition is not limited to the above-mentioned conditions, but may be appropriately set corresponding to the game.

The index data 546 includes information that indicates the movie data formed based on the game image of the reproduced game and index information used to select the data from a plurality of movies. The index data 546 is generated corresponding to each game play when the game play has been completed. As shown in FIG. 13, the index data 546 includes thumbnail image data 546a and index text 547, for example. Information included in the key log file 532 of the reproduced game play is appropriately stored in the index text 547, for example. The index text 547 includes a play ID 547a, a play date 547b (equivalent to the registration date 532b), installation location information 547c, first player information 547d, second player information 547e, and play result information 547f, for example.

Functional Configuration of Capture Server

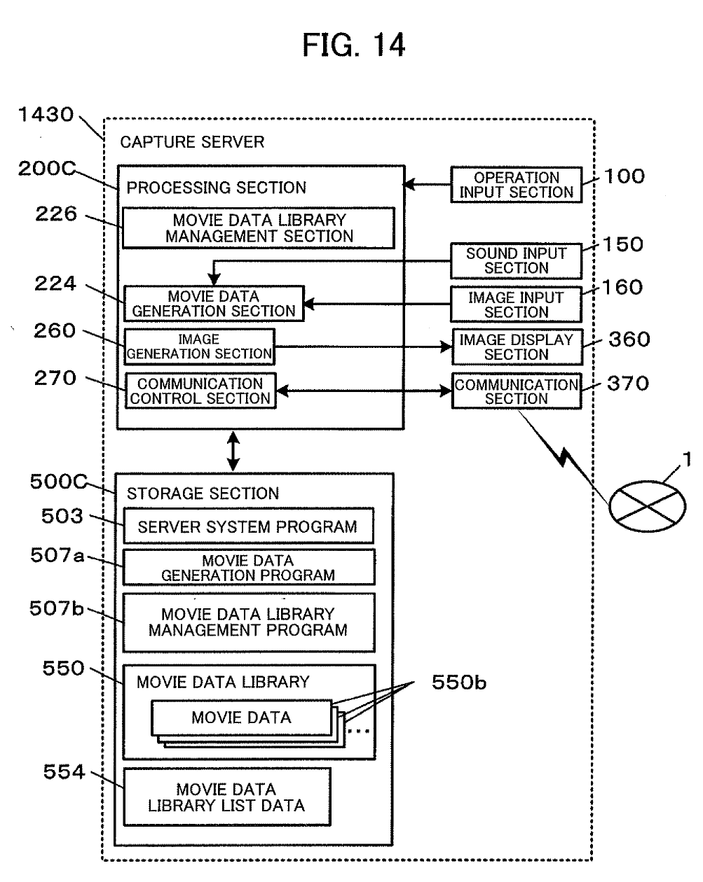

FIG. 14 is a functional block diagram showing a functional configuration example of the capture server 1430 according to this embodiment. Note that the functional blocks identical to those of the arcade game device 1300, the game server 1410, and the replay server 1420 are indicated by the same reference numerals. Detailed description of these functional blocks is omitted.

The capture server 1430 is a server device that generates movie data from the game image reproduced by the replay server 1420, and registers and stores the movie data in the movie data library 550 stored in the storage 1432.

The capture server 1430 includes an operation input section 100 that allows the operator to perform an operation input when managing the capture server 1430, a sound input section 150, an image input section 160, a processing section 200C, an image display section 360, a communication section 370, and a storage section 500C. The storage section 500C of the capture server 1430 includes the storage 1432 shown in FIG. 1.

The sound input section 150 and the image input section 160 respectively receive a sound signal and an image signal from the outside. The sound input section 150 and the image input section 160 may be implemented by an RCA terminal, a D terminal, an A/D conversion circuit, an amplifier circuit, and the like. The sound input section 150 and the image input section 160 output the received sound signal and image signal to the processing section 200C.

The processing section 200C of the capture server 1430 is implemented by electronic components such as a microprocessor, an image drawing processor, an application-specific integrated circuit (ASIC), and an IC memory. The processing section 200 exchanges data with each functional section, and controls the operation of the capture server 1430 by performing various calculation processes based on a given program, data, and the operation input signal from the operation input section 100.

The storage section 500C of the capture server 1430 stores a predetermined program and data, and is used as a work area for the processing section 200C. The storage section 500C temporarily stores the results of calculations performed by the processing section 200C according to various programs, for example. The function of the storage section 500C is implemented by an IC memory (e.g., RAM or ROM), a magnetic disk (e.g., hard disk), an optical disk (e.g., CD-ROM or DVD), or the like.

In this embodiment, the processing section 200C of the capture server 1430 includes a movie data generation section 224 and a movie data library management section 226.

The movie data generation section 224 digitizes the sound signal and the image signal input from the sound input section 150 and the image input section 160, and generates movie data in a given movie data format while synchronizing the sound and the image. The movie data generation section 224 stores and registers the generated movie data in the movie data library 550 stored in the storage section 500C (particularly the storage 1432) corresponding to the index data 546 received from the replay server 1420.

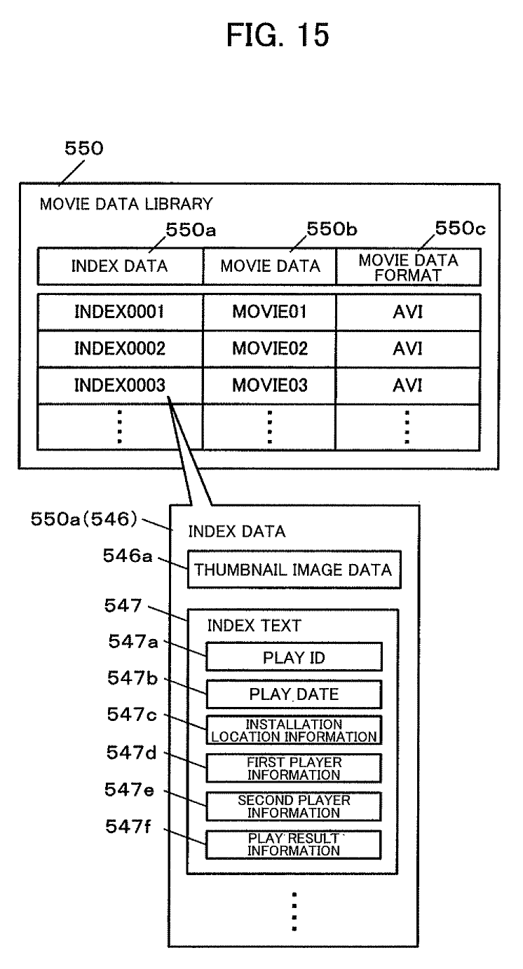

As shown in FIG. 15, the movie data generation section 224 stores generated movie data 550b and a movie data format 550c that indicates the movie data format of the corresponding movie data corresponding to index data 550a (substantially the same as the index data 546) received before or after the replay sound and image, for example. In this embodiment, movie data in the AVI format is generated in default setting. Note that another movie data format may also be employed.

The sound input section 150, the image input section 160, and the movie data generation section 222 may be implemented by a video capture board having a movie data generation function.

The processing section 200C of the capture server 1430 includes the movie data library management section 226. The movie data library management section 226 performs a management process that selects and deletes the movie data that has been registered in the library over a given period of time (e.g., seven days).

The storage section 500C of the capture server 1430 stores a server system program 503, a movie data generation program 507a that causes the processing section 200C to function as the movie data generation section 224, a movie data library management program 507b that causes the processing section 200C to function as the movie data library management section 226, the movie data library 550, and movie data library list data 554.

The movie data library list data 554 indicates a list of the index data 550a relating to the movie data that is stored and registered in the movie data library 550.

Functional configuration of movie distribution server

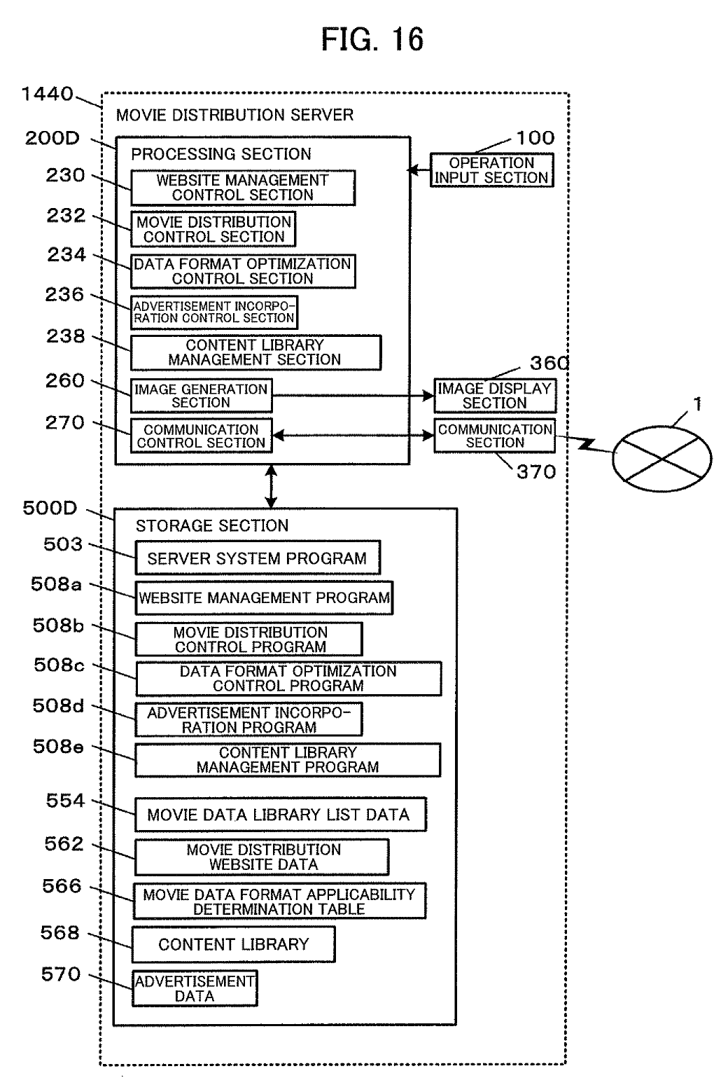

FIG. 16 is a functional block diagram showing a functional configuration example of the movie distribution server 1440 according to this embodiment. Note that the functional blocks identical to those of the arcade game device 1300, the game server 1410, the replay server 1420, and the capture server 1430 are indicated by the same reference numerals. Detailed description of these functional blocks is omitted.

The movie distribution server 1440 is a server device that manages the movie distribution website, and streams a movie requested from the portable terminal 1500 that accesses the movie distribution website.

The movie distribution server 1440 according to this embodiment includes an operation input section 100 that allows the operator to perform a management operation, a processing section 200D, an image display section 360 that displays an image as a management operation interface, a communication section 370, and a storage section 500D. The storage section 500D of the movie distribution server 1440 includes the storage 1442 shown in FIG. 1.

The processing section 200D of the movie distribution server 1440 is implemented by electronic components such as a microprocessor, an image drawing processor, an application-specific integrated circuit (ASIC), and an IC memory. The processing section 200D exchanges data with each functional section, and controls the operation of the movie distribution server 1440 by performing various calculation processes based on a given program, data, and the operation input signal from the operation input section 100.

The storage section 500D of the movie distribution server 1440 stores a predetermined program and data, and is used as a work area for the processing section 200D. The storage section 500D temporarily stores the results of calculations performed by the processing section 200D according to various programs, for example. The function of the storage section 500D is implemented by an IC memory (e.g., RAM or ROM), a magnetic disk (e.g., hard disk), an optical disk (e.g., CD-ROM or DVD), or the like.

In this embodiment, the processing section 200D of the movie distribution server 1440 includes a website management control section 230, a movie distribution control section 232, a data format optimization control section 234, an advertisement incorporation control section 236, and a content library management section 238.

The website management control section 230 manages the movie distribution website, such as updating a distributable movie list based on the movie data library list data 554 received from the capture server 1430. Specifically, the website management control section 230 incorporates the movie data included in the movie data library list data 554 in the website, and cancels incorporation of the movie data that is incorporated in the website and is not included in the movie data library list data 554. The management process may be implemented by appropriately applying a website management method for a movie posting website or a movie sharing website, for example.

The movie distribution control section 232 performs control for streaming a movie in response to a request from the portable terminal 1500 that has accessed the movie distribution website. The movie distribution process may be basically controlled by appropriately applying a website management method for a movie posting website or a movie sharing website, for example.

When the movie distribution control section 232 according to this embodiment has received a movie distribution request, the movie distribution control section 232 searches the content library 568 stored in the storage section 500D for a content including the requested movie data, and delivers the content. When a content including the requested movie data is not stored in the content library 568, the movie distribution control section 232 acquires the movie data from the capture server 1430 together with the corresponding index data 550, registers the movie data in the content library 568, and delivers the movie data.

The data format optimization control section 234 acquires specification information relating to movie processing and movie display capability, or information that allows determination of the specification of movie display capability, from the distribution target portable terminal 1500, and determines whether or not the data format of the distribution target movie data is appropriate for the portable terminal 1500. When the data format optimization control section 234 has determined that the data format of the distribution target movie data is not appropriate for the portable terminal 1500, the data format optimization control section 234 causes the distribution target movie data and information relating to the conversion target data format to be transmitted to the movie conversion server 1450 through the communication control section 270 and the communication section 370.

As the specification information, information relating to the resolution and the aspect ratio (e.g., information relating to the reproducible movie data format), the display size and the corresponding aspect ratio of the image display device 1522 (see FIG. 1), the OS, the CPU clock speed, or the like may be appropriately utilized. In this embodiment, the user-agent character string of the HTTP request header transmitted from the portable terminal 1500 is utilized as the specification information. The model of the portable terminal 1500 is determined from the character string. When the model of the portable terminal 1500 has been determined, the movie reproduction capability can be determined from the specification of the device provided by the manufacturer or a communication service provider.

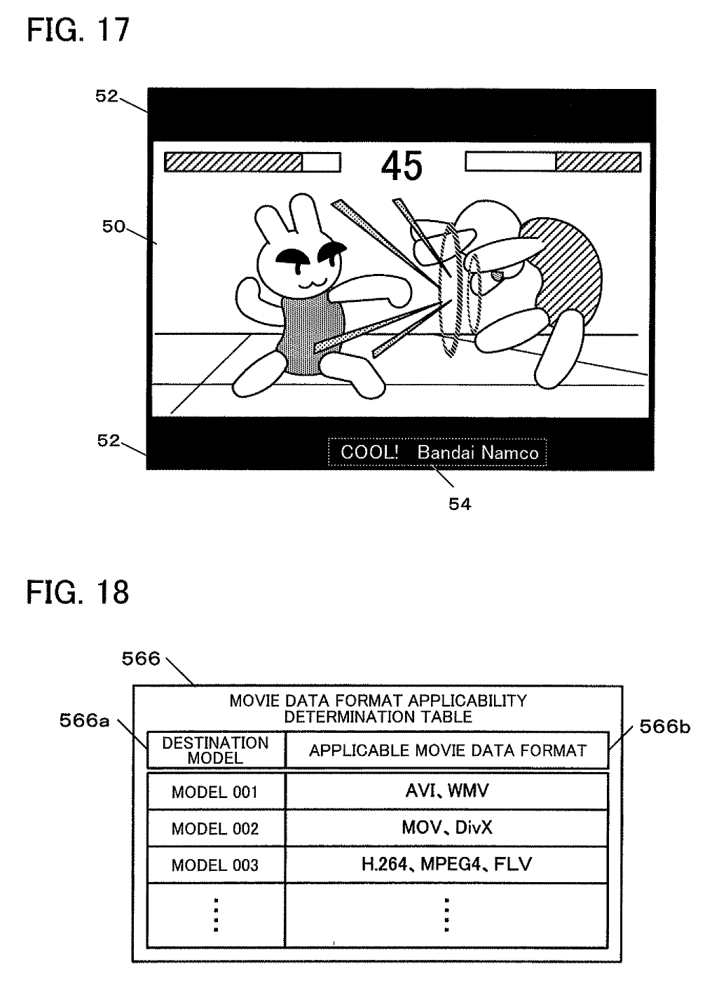

The advertisement incorporation control section 236 incorporates given advertisement information in the distribution target movie data. The advertisement information may be incorporated by synthesizing advertisement characters on the upper side and the lower side of the screen in the same manner as subtitles, or inserting a given commercial movie before the movie data, for example. In this embodiment, the aspect ratio of the movie data generated by the capture server 1430 is 16:9. The movie distribution server 1440 changes the aspect ratio to 4:3 by setting black areas 52 on the upper side and the lower side of the movie display section 50 (see FIG. 17), and synthesizing advertisement information 54 stored in the storage section 500D as advertisement data 570 so that the advertisement characters are displayed in the black areas 52.

The content library management section 238 stores and registers the movie data provided with an advertisement in the content library 568 stored in the storage section 500D as a content, and deletes a content that satisfies a given deletion target selection condition.

The storage section 500D of the movie distribution server 1440 stores a website management program 508a that causes the processing section 200D to function as the website management control section 230, a movie distribution control program 508b that causes the processing section 200D to function as the movie distribution control section 232, a data format optimization control program 508c that causes the processing section 200D to function as the data format optimization control section 234, an advertisement incorporation program 508d that causes the processing section 200D to function as the advertisement incorporation control section 236, and a content library management program 508e that causes the processing section 200D to function as the content library management section 238.

The storage section 500D of the movie distribution server 1440 also stores the movie data library list data 554 received from the capture server 1430, movie distribution website data 562 necessary for managing the movie distribution website, a movie data format applicability determination table 566, the content library 568, and the advertisement data 570.

As shown in FIG. 18, the movie data format applicability determination table 566 stores a destination model 566a and an applicable movie data format 566b that indicates the movie data format reproducible by the corresponding model, for example.

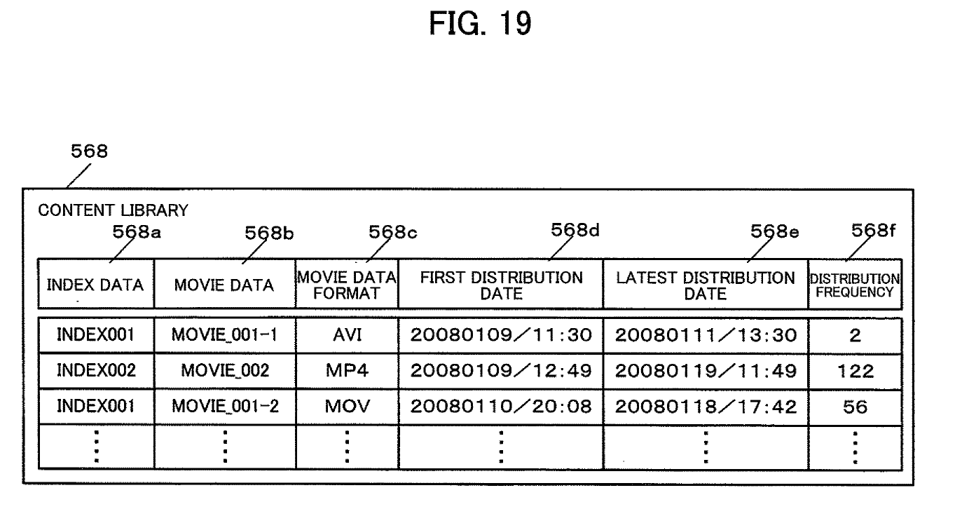

As shown in FIG. 19, the content library 568 stores index data 568a, movie data 568b that mainly forms a content, a movie data format 568c, a first distribution date 568d, a latest distribution date 568e, and a total distribution frequency 568f, for example. The index data 568a corresponds to the index data 550 acquired from the capture server 1430 when acquiring the movie data. Identification information relating to the movie data format of the movie data is stored as the movie data format 568c.

Contents stored in the content library 568 that contain an identical movie but differ in movie data format are considered to be different contents. In the example shown in FIG. 19, movie data “MOVIE_{—}001-1” and movie data “MOVIE-001-2” correspond to identical index data 568a “INDEX001”. Therefore, the movie data “MOVIE_{—}001-1” and the movie data “MOVIE_{—}001-2” correspond to identical movie data (stored in the movie data library 550 of the capture server 1430). However, since the movie data “MOVIE_{—}001-1” and the movie data “MOVIE_{—}001-2” differ in movie data format 568c, the movie data “MOVIE_{—}001-1” and the movie data “MOVIE_{—}001-2” are registered as different contents.

Functional Configuration of Movie Conversion Server

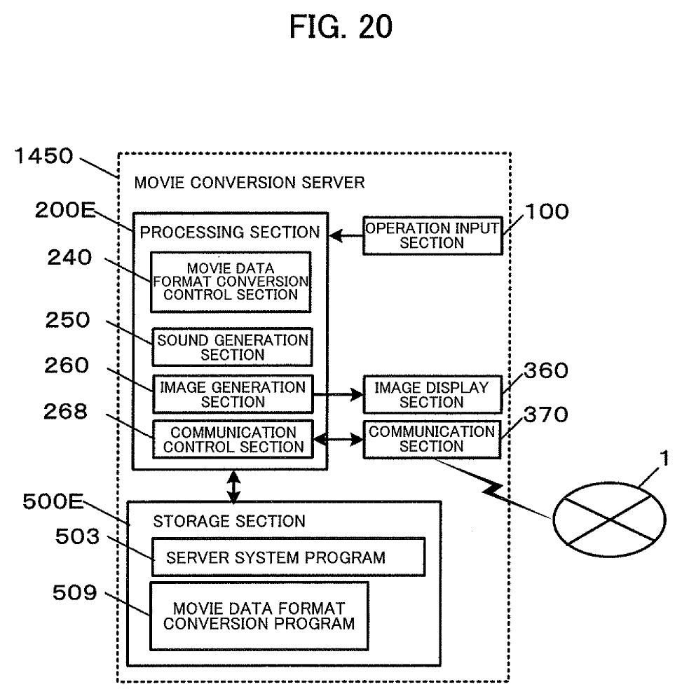

FIG. 20 is a functional block diagram showing a functional configuration example of the movie conversion server 1450 according to this embodiment. Note that the functional blocks identical to those of the arcade game device 1300, the game server 1410, the replay server 1420, the capture server 1430, and the movie distribution server 1440 are indicated by the same reference numerals. Detailed description of these functional blocks is omitted.

The movie conversion server 1450 is a server device that converts the movie data format of the movie data acquired from an external device into the movie data format requested by the external device and returns the converted movie data to the external device.

The movie conversion server 1450 includes an operation input section 100 for the operator to manage the movie conversion server 1450, a processing section 200E, an image display section 360, a communication section 370, and a storage section 500E.

The processing section 200E of the movie conversion server 1450 is implemented by electronic components such as a microprocessor, an image drawing processor, an application-specific integrated circuit (ASIC), and an IC memory. The processing section 200E exchanges data with each functional section, and controls the operation of the movie conversion server 1450 by performing various calculation processes based on a given program, data, and the operation input signal from the operation input section 100.

The storage section 500E of the movie conversion server 1450 stores a predetermined program and data, and is used as a work area for the processing section 200E. The storage section 500E temporarily stores the results of calculations performed by the processing section 200E according to various programs, for example. The function of the storage section 500E is implemented by an IC memory (e.g., RAM or ROM), a magnetic disk (e.g., hard disk), an optical disk (e.g., CD-ROM or DVD), or the like.

In this embodiment, the processing section 200E of the movie conversion server 1450 functions as a movie data format conversion control section 240 that reads and executes a movie data format conversion program 509 stored in the storage section 500E to convert the data format of the acquired movie data into another data format, and returns the converted movie data to the requester.

### Process Flow

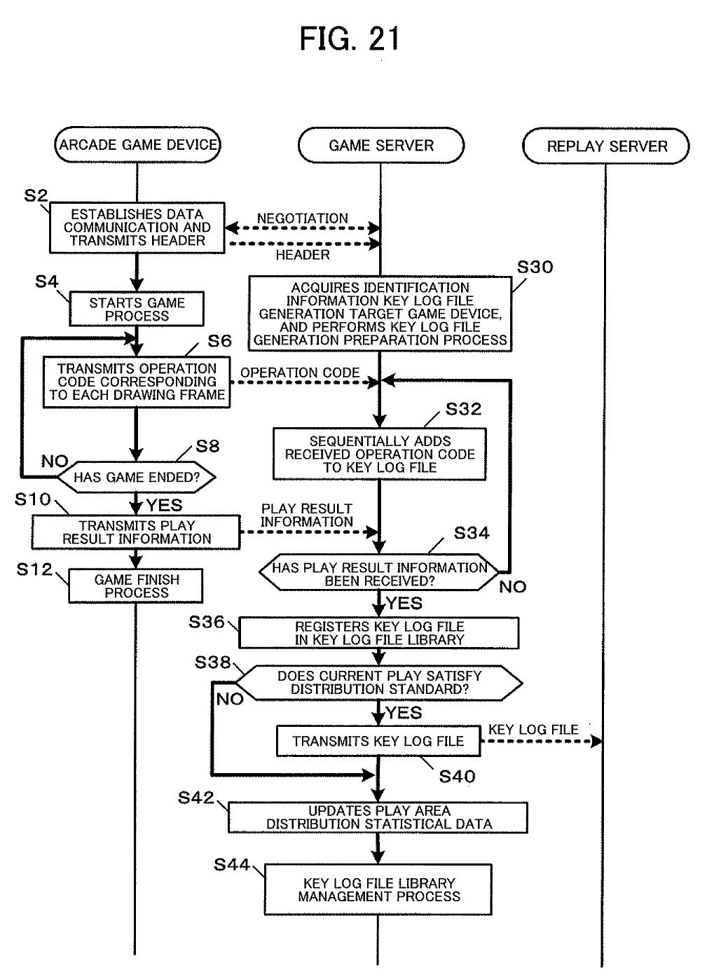

The flow of the process according to this embodiment is described below with reference to FIGS. 21 to 24.

As shown in FIG. 21, the arcade game device 1300 performs a process (negotiation process) relating to matching with the opposing device and establishment of data communication before the game starts in the same manner as in a known online match game. The arcade game device 1300 then establishes data communication with the game server 1410, and transmits the header 400 (see FIG. 4) (step S2).

The game server 1410 acquires the game device identification information 401 (e.g., IP address or device identification number) relating to the arcade game devices 1300 used for the match play, and performs a preparation process such as allocating a storage area for generating the key log file 532 (step S30). Specifically, the game server 1410 generates the key log file 532, allocates the play ID 532a, and sets the registration date 532b. The game server 1410 stores the header 400 transmitted from one of the arcade game devices 1300 as the first header 532c, and stores the header 400 received from the other arcade game device 1300 as the second header 532e (see FIG. 6).

When the arcade game devices 1300 have started the game process (step S4), the arcade game devices 1300 continually exchange information such as the operation data to proceed with the game. The arcade game device 1300 transmits the game device identification information 417, the frame number 418, and the operation code 420 that indicates the operation input performed by the player to the game server 1410 corresponding to each drawing frame of the image display device 1222 (step S6). The arcade game device 1300 repeats the step S6 until the game ends (NO in step S8).

The game server 1410 compares the received game device identification information 417 with the game device identification information 401 included in the first header 532c and the second header 532e of the key log file 532, and sequentially adds the received game device identification information 417, frame number 418, and operation code 420 to the first player key log data 532d or the second player key log data 532f of the key log file 532 (step S32).

When a given game finish condition has been satisfied (YES in step S8), the arcade game device 1300 generates the play result information 422 and transmits the play result information 422 to the game server 1410 (step S10). The play result information 422 includes the game device identification information relating to the arcade game device 1300 of the player who won the game as information relating to the winner of the match play.

The arcade game device 1300 then executes a given game finish process, updates the information (e.g., player level and match record) stored in the game card 1360 based on the game results, and finishes executing the fighting game (step S12). When the game server 1410 has received the play result information 422 from the arcade game device 1300 (YES in step S34), the game server 1410 determines that the match play has ended, and registers the key log file 532 in the key log file library 530 (step S36).

The above description has been given taking an example in which the arcade game device 1300 continually performs the process in the step S6 during the game process. Note that the arcade game device 1300 may store information relating to the operation code during the game process, and collectively transmit the stored information to the game server 1420 after the game has ended.

The game server 1410 then determines whether or not the match play of the registered key log file 532 satisfies a given distribution standard based on the distribution standard data 536 (see FIG. 7) (step S38).

Specifically, the game server 1410 determines whether or not the key log file 532 satisfies the selection standard 536b corresponding to the preferential order 536a of the distribution standard data 536. When the game server 1410 has determined that the key log file 532 satisfies the selection standard 536b, the game server 1410 draws lots at the corresponding selection probability 536c. The game server 1410 determines that the key log file 532 satisfies the distribution standard when the key log file 532 has been elected. When the game server 1410 has determined that the key log file 532 does not satisfy the selection standard 536b, the game server 1410 determines whether or not the key log file 532 satisfies the subsequent selection standard 536b. When the game server 1410 has determined that the key log file 532 does not satisfy each of the selection standards 536b, or when the key log file 532 is not elected by lottery based on the selection probability 536c, the game server 1410 determines that the key log file 532 does not satisfy the distribution standard.

Therefore, attractive game play or game play appropriate for promoting communication between the players in each area can be selectively distributed while limiting the number of match play results to be distributed (i.e., distributing a limited number of match play results), by providing the step S38 and setting the distribution standard data 536.

The game server 1410 transmits the key log file 532 that has been determined to satisfy the distribution standard to the replay server 1420 (step S40). The game server 1410 updates the play area distribution statistical data 538 referring to the installation location information 414 included in the first header 532d or the second header 532e of the key log file 532 that has been transmitted (step S42), and manages the key log file library 530 (step S44). Specifically, the game server 1410 refers to the registration date 532b of each key log file 532, and automatically deletes the key log file 532 that has been registered over a given period of time (e.g., 30 days).

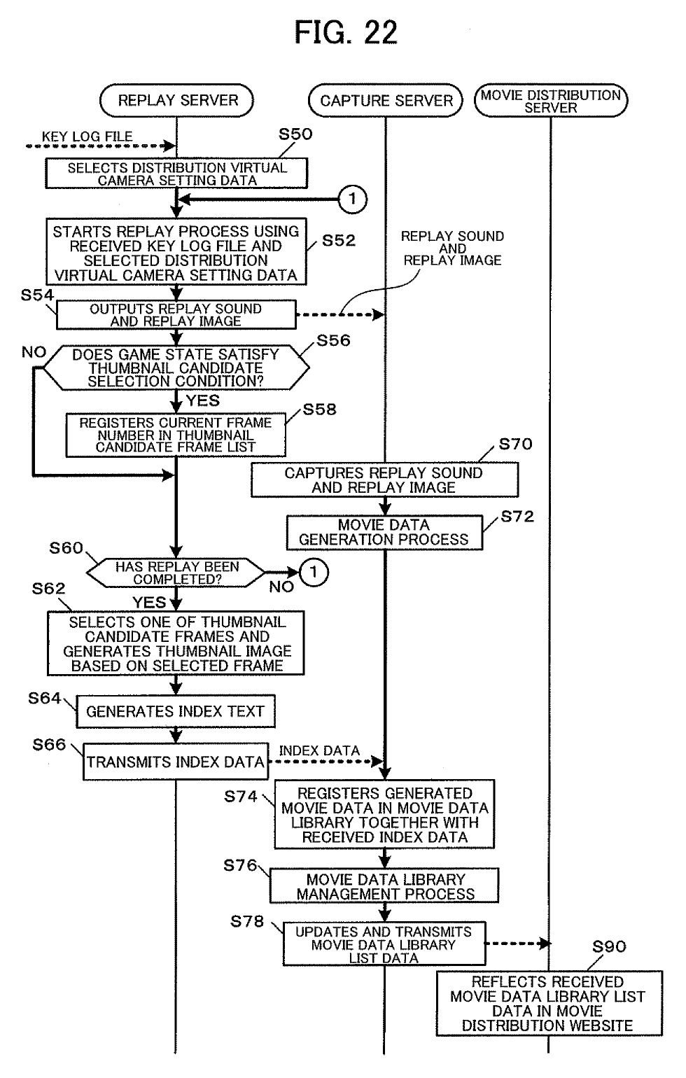

As shown in FIG. 22, the replay server 1420 that has received the key log file 532 from the game server 1410 selects the distribution virtual camera setting data 540c that satisfies the selection condition 540b referring to the player information included in the first header 532d and the second header 532e of the key log file 532 and the distribution virtual camera setting table 540 (step S50).

The replay server 1420 starts the replay process using the received key log file 532 and the selected distribution virtual camera setting data 540c to reproduce the match play (step S52). Note that an introduction scene in which the characters are introduced (normally used in a fighting game) is also reproduced in the same manner as the match play in the arcade game device 1300.

The replay server 1420 outputs the game sound and the game image photographed by a special distribution camera movement to the capture server 1430 as the replay sound and the replay image (step S54).

The replay server 1420 compares the thumbnail candidate selection condition data 542 with the current game state during the replay process. When the thumbnail candidate selection condition is satisfied (YES in step S56), the replay server 1420 sequentially stores the current frame number (or the time elapsed from the start of replay) in the thumbnail candidate frame list 544 (step S58).

When the replay server 1420 has completed replay (YES in step S60), the replay server 1420 randomly selects one of the frame numbers stored in the thumbnail candidate frame list 544, generates a game image in the selected frame, and resizes the game image to a given size to generate a thumbnail image (step S62).

The replay server 1420 then generates the index text 547 (see FIG. 13) based on the first header 532c and the second header 532e of the key log file 532 received from the game server 1410 (step S64), and transmits the index data 546 including the thumbnail image that has been generated to the capture server 1430 (step S66).

The capture server 1430 captures the replay sound and the replay image (step S70), and generates movie data in a given movie data format (step S72).

When the capture server 1430 has received the index data 546 from the replay server 1420, the capture server 1430 determines that replay has ended, and registers the generated movie data in the movie data library 550 (see FIG. 15) together with the received index data 546 (step S74).

The replay server 1420 then performs the movie data library management process (step S76). In the movie data library management process, the replay server 1420 considers the play date 547b included in the index data 550a to be the registration date, and automatically deletes the movie data 522 that has been registered over a given period of time (e.g., 14 days). The replay server 1420 updates the movie data library list data 554 (i.e., a list of the movie data 552 registered in the movie data library 550 after the management process), and transmits the movie data library list data 554 to the movie distribution server 1440 (step S78).

The movie distribution server 1440 reflects the received movie data library list data 554 in the movie distribution website so that the movie data stored in the movie data library 550 can be distributed (step S90).

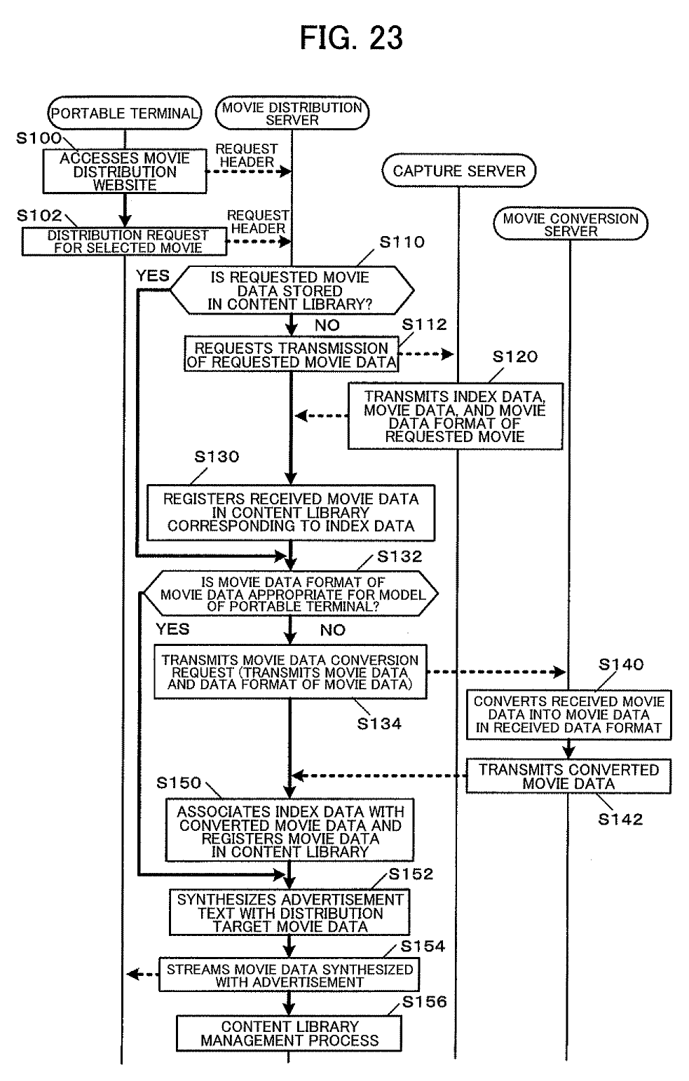

As shown in FIG. 23, the portable terminal 1500 accesses the movie distribution website in the same manner as a known website browsing process through the Internet (step S100). In this case, the movie distribution server 1440 utilizes the user-agent information of the HTTP request header transmitted from the portable terminal 1500 to determine the model of the portable terminal 1500, for example. When the portable terminal 1500 stores the model information or the specification information relating to the movie reproduction capability, the movie distribution server 1440 may acquire the model information or the specification information in the background when the portable terminal 1500 accesses the movie distribution website.

The movie distribution website managed by the movie distribution server 1440 according to this embodiment is basically implemented in the same manner as a known movie distribution website.

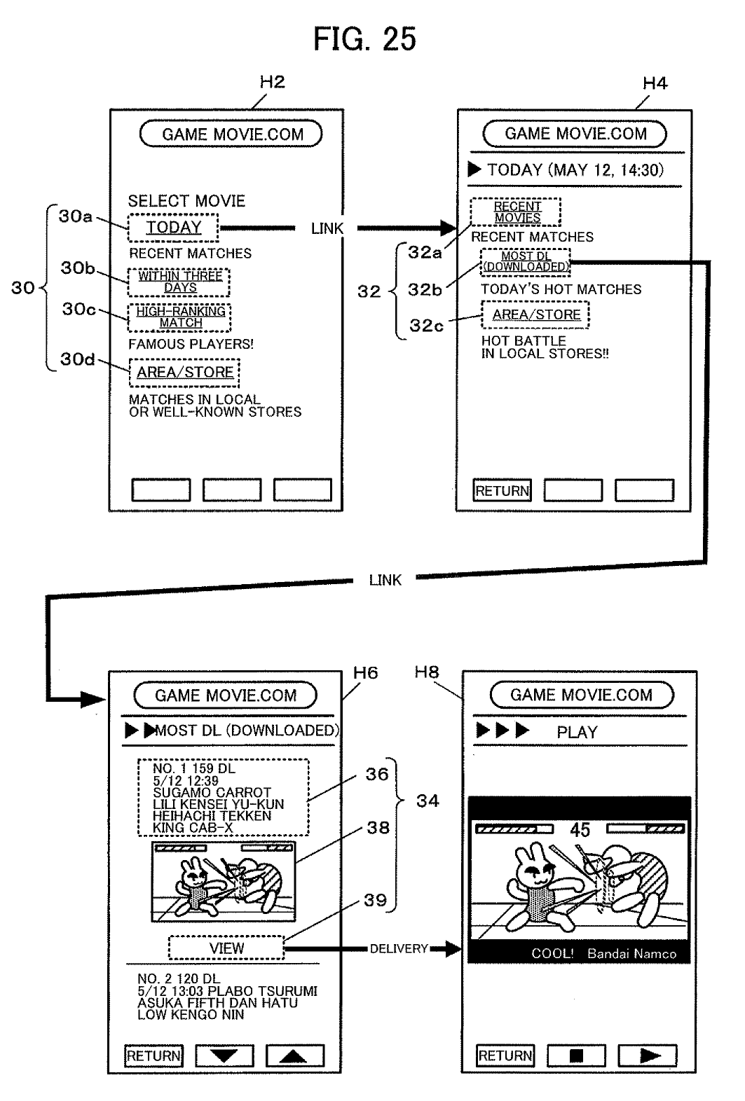

For example, the movie distribution website has a configuration shown in FIG. 25. A homepage H2 has classification indications (links) 30 that allow the user to select an item from the information included in each index data 550a of the movie data library list data 554. For example, a classification display 30a “Today” is linked to a page H4.

The page H4 has sub-classification indications (links) 32 that allow the user to select an item based on the information included in the index data 550a and the information included in the content library 568 (e.g., latest distribution date 568e and total distribution frequency 568f). For example, when the user selects the sub-classification indication “Most DL (downloaded)”, movie information 34 that indicates the movies of which the play date 547b (see FIG. 15) of the index data 550a stored in the movie data library list data 554 is today and can be selected in descending order of the total distribution frequency 568f stored in the content library 568 is displayed to be scrollable (see page H6). The movie information 34 includes text information 36 (e.g., player information), a thumbnail image 38, and a link 39.

When the user has selected the link 39 of arbitrary movie information 34 on the page H6 using the portable terminal 1500, the portable terminal 1500 transmits a distribution request for the selected movie to the movie distribution server 1440 (FIG. 23; step S102).

The movie distribution server 1440 determines whether or not the content including the movie data corresponding to the received distribution request is stored in the content library 568. (step S110). When the movie distribution server 1440 has determined that the content is not stored in the content library 568 (NO in step S110), the movie distribution server 1440 requests the capture server 1430 to transmit the movie data of the requested movie (step S112). Specifically, the movie distribution server 1440 transmits the identification data (e.g., play ID) of the requested movie together with the transmission request.

The capture server 1430 reads the index data 550a, the movie data 550b, and the movie data format 550c from the movie data library 550 in response to the request received from movie distribution server 1440, and transmits the index data 550a, the movie data 550b, and the movie data format 550c to the movie distribution server 1440 (step S120). The movie distribution server 1440 receives the index data 550a, the movie data 550b, and the movie data format 550c, and registers the index data 550a, the movie data 550b, and the movie data format 550c in the content library 568 (step S130).

The movie distribution server 1440 then determines whether or not the movie data format 568c of the movie data 568b of the content corresponding to the movie requested from the portable terminal 1500 is appropriate for the movie display capability of the portable terminal 1500 (requester) (step S132).

Specifically, the movie distribution server 1440 determines the model of the portable terminal 1500 from the user-agent character string included in the received request header, and compares the applicable movie data format 566b stored in the movie data format applicability determination table 566 corresponding to the destination model 566a corresponding to the model of the portable terminal 1500 with the movie data format 568c of the movie data 568b of the content corresponding to the requested movie.

When the movie distribution server 1440 has determined that the movie data format 568c is not appropriate for the movie display capability of the portable terminal 1500 (NO in step S132), the movie distribution server 1440 transmits the identification data relating to the data format corresponding to the movie data 568b of the requested movie stored in the content library 568 to the movie conversion server 1450 to request the movie conversion server 1450 to convert the movie data (step S134).

The movie conversion server 1450 converts the received movie data into movie data in the received data format (step S140), and transmits the converted movie data to the movie distribution server 1440 (step S142).

The movie distribution server 1440 associates the index data with the converted movie data received from the movie conversion server 1450, and registers the movie data in the content library 568 as a new content (step S150). The movie data appropriate for the movie display capability of the destination portable terminal 1500 can thus be acquired. Note that it is unnecessary to convert the movie when the movie data format 568c of the movie data 568b of the content registered in the content library 568 is appropriate for the movie display capability of the destination portable terminal 1500.

The movie distribution server 1440 then synthesizes the advertisement information set as the advertisement data 570 with the distribution target movie data 568b (step S152), and streams the movie data synthesized with the advertisement information to the portable terminal 1500 (requester) (step S154). The portable terminal 1500 that has received the movie data reproduces the movie (see page H8 in FIG. 25).

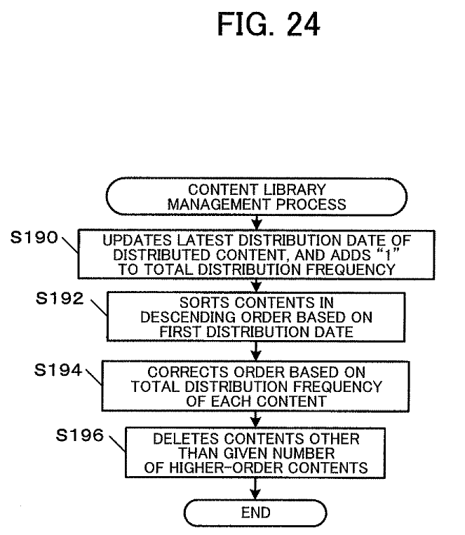

The movie distribution server 144 then manages the content library (step S156). As shown in FIG. 24, the movie distribution server 144 updates the latest distribution date 568d of the content that has been distributed in the step S154, and adds “1” to the total distribution frequency 568f to update the distribution frequency 568f (step S190). The movie distribution server 144 then sorts the registered contents in descending order based on the first distribution date 568c (step S192), and corrects the order based on the total distribution frequency 568f of each content (step S194). For example, the movie distribution server 144 may correct the order stepwise (e.g., increase the ranking by five when the total distribution frequency 568f is 0 to 20, increase the ranking by 10 when the total distribution frequency 568f is 21 to 50, and increase the ranking by 15 when the total distribution frequency 568f is 51 to 100), or may calculate an increase in ranking by a given function. The movie distribution server 1440 then deletes the contents other than a given number of higher-order contents (step S196).

According to this embodiment, since the movies of the fighting games played in various areas can be delivered to the portable terminal 1500, the user of the portable terminal 1500 can observe a match between other players without visiting the place where the players play a match. This prompts the players to observe or evaluate a match between other players to revitalize the player community.

According to this embodiment, since the movie distributed to the portable terminal 1500 is created based on the game image photographed by the virtual camera setting appropriate for the movie display capability of the destination portable terminal 1500, the user can easily observe the characters even if the portable terminal 1500 has a small liquid crystal display that is generally used for portable terminals.

Since the moving amount, the moving speed, the zoom change speed, and the like of the virtual camera (camera work) are reduced as compared with those of the arcade game device 1300, the amount of movement of the characters on the screen is reduced. Therefore, problems such as block noise due to compression can be suppressed as much as possible even if the data is compressed when generating the movie data. As a result, the visual quality of the portable terminal 1500 can be improved.

Since the movie data in a data format appropriate for the destination portable terminal 1500 can be delivered to the portable terminal 1500, the visibility of the movie can be further improved.

The contents registered in the content library 568 are deleted in the order from the contents registered earlier when a given number of contents have been registered, and the sorting order is corrected based on the total distribution frequency 568f. Therefore, a content with a high distribution frequency (i.e., a popular content) is allowed to remain. Specifically, the movie distribution website is maintained so that the movie of the fighting game that has been played somewhere is necessarily added, and popular contents can be distributed for a long period of time as compared with less popular contents.

The thumbnail image assigned to the movie to be distributed is not generated based on a randomly selected image, but is generated based on an impressive scene during the game play. This provides the user with more accurate movie information while attracting a considerable attention.

Modification

The embodiments to which the invention is applied have been described above. Note that the invention is not limited thereto. The elements may be appropriately modified, added, or omitted without departing from the spirit and scope of the invention.

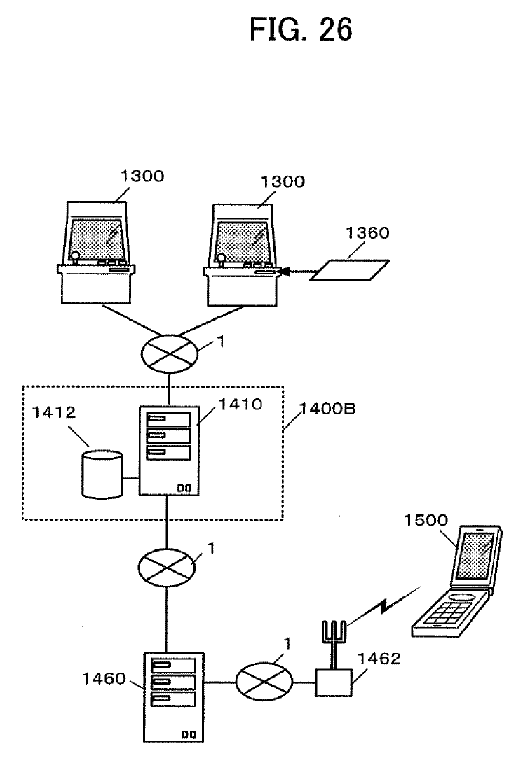

The above embodiments have been described taking an example in which a plurality of server devices cooperate to implement the game movie distribution system 1400. Note that a game movie distribution system 1400B shown in FIG. 26 may be implemented by a single server device.

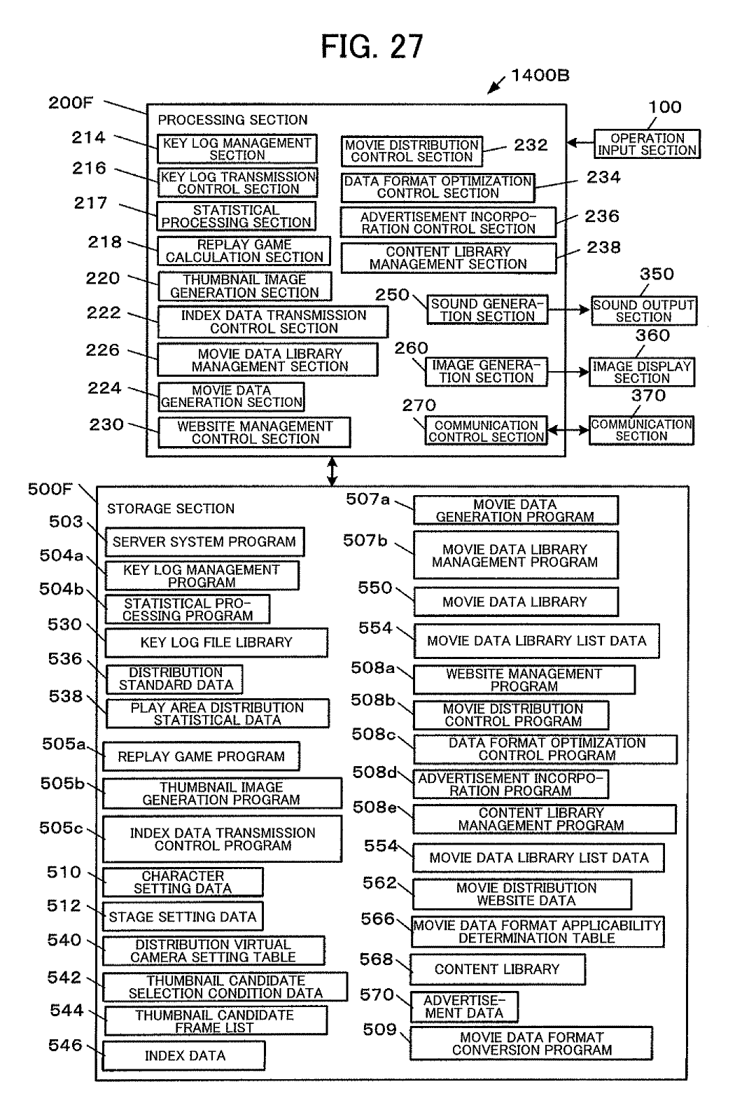

In this case, the functional blocks provided in the game server 1410, the replay server 1420, the capture server 1430, the movie distribution server 1440, and the movie conversion server 1450 can be integrated as shown in FIG. 27. Therefore, the processes relating to data transmission and reception between the servers can be appropriately omitted from the steps shown in FIGS. 21 to 24. Note that all of the server devices included in the game movie distribution system 1000 need not necessarily be integrated. Specifically, the functions may be integrated arbitrarily, such as implementing the replay server 1420 and the capture server 1430 using a single server device.

Since the functions can be integrated arbitrarily, the thumbnail image generation function (i.e., the thumbnail image generation section 220 in FIG. 9) may be provided in the capture server 1430 instead of the replay server 1420, for example. In this case, the replay server 1420 generates the thumbnail candidate frame list 544, but does not generate the thumbnail image based on the thumbnail candidate frame list 544 (i.e., the step S62 is omitted). In the step S66, the replay server 1420 transmits the index text 547 (see FIG. 13) to the capture server 1430 instead of the index data. The capture server 1430 generates the movie data in the step S72, and then executes a process corresponding to the step S62. In the step S74, the capture server 1430 generates the index data 546 using the thumbnail image generated by the capture server 1430 and the index text 547 received from the replay server 1420, adds the index data 546 to the movie data, and registers the movie data in the movie data library 550.

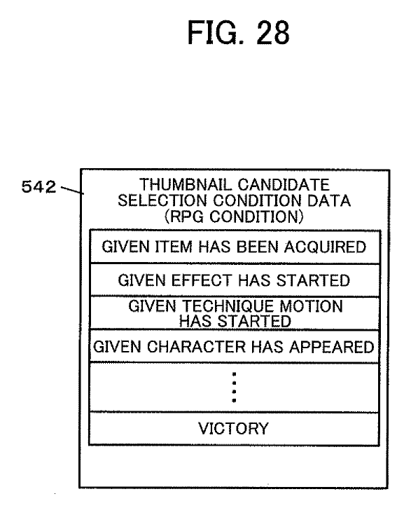

The above embodiments have been described taking an example in which the video game to be distributed is the fighting game. Note that the video game is not limited thereto. The video game may be a role-playing game (RPG), a car racing game, or the like. In this case, the thumbnail candidate selection condition data 542 is appropriately set corresponding to the game. When the video game is an RPG, for example, the thumbnail candidate selection condition data 542 may be set as shown in FIG. 28. In this case, an impressive scene (e.g., a scene in which a character acquires a special item, a scene in which a character practices a special magic or technique, a scene in which a character fights against a rare enemy character, or a scene in which a special character joins the player's party) in the RPG can be used as the thumbnail image. When the video game is a car racing game, an impressive scene during the race can be used as the thumbnail image by setting a moment when a character ranks first, a goal scene when the fastest lap is updated, or an effect timing (e.g., jump or backfire) as the condition.

In the above embodiments, the portable terminal 1500 may be a consumer game device, a desktop personal computer, or the like. Each server device may be implemented by an information processing device other than the server device insofar as an identical function can be implemented.

In the content library management process, contents that contain an identical movie but differ in movie data format are considered to be different contents. In the above embodiments, converted movie data and the original movie data are associated with identical index data 568a (i.e., the converted movie data and the original movie data are associated with each other via the index data 568a). Therefore, when one of the original movie data and the converted movie data has been selected as the deletion target, the other of the original movie data and the converted movie data may also be deleted. This prevents a situation in which only one of the contents that contain an identical movie remains. When one of the original movie data and the converted movie data is excluded from the deletion target, the other of the original movie data and the converted movie data may also be excluded from the deletion target even if it is selected as the deletion target.

In the above embodiments, movie data is selected as the deletion target based on the time elapsed after registration when managing the movie data library 550. Note that the condition is not limited thereto.

For example, the movie distribution server 1440 may select the maximum value of the total distribution frequency 568f of the movie data that has identical index data corresponding to the index data 568a of the content registered in the content library 568, create a list of the selected maximum values, and transmit the list to the movie data library 550. The movie data of which the total distribution frequency 568f is less than a reference value after a given period of time has elapsed may be deleted referring to the list. A list of the play ID extracted from the index data 568a of the movie data deleted in the content library management process may be transmitted to the capture server 1430, and the capture server 1430 may delete the movie data corresponding to the play ID contained in the list, for example.

The above embodiments have been described taking an example in which the movie data generation virtual camera setting is defined by the distribution virtual camera setting table 540. Note that a virtual damper that affects a change in movement and direction of the virtual camera may be set while utilizing the normal virtual camera setting data 514. Specifically, when the replay game calculation section 218 sets the focus point in the three-dimensional virtual space based on the position of the character object and controls the position and/or rotation of the virtual camera CM based on the normal virtual camera setting data 514 so that the line-of-sight direction of the virtual camera CM aims at the current position of the focus point in the game play reproduction process, the replay game calculation section 218 sets a virtual damper that serves as resistance against a change in movement and direction of the virtual camera CM, calculates the amount of change in movement and direction of the virtual camera CM based on physical calculations taking account of the damper, and controls the virtual camera CM based on the calculation results. In this case, a change in screen is reduced as compared with the normal setting in the same manner as in the above embodiments so that movie data that can be easily observed on the small display screen of the portable terminal 1500 can be obtained. Moreover, block noise can be suppressed when decoding the movie data so that the reproduction quality can be improved.

The above embodiments have been described taking an example in which the distribution frequency 568f of the content library 568 is incremented each time the movie data is delivered to count the total distribution frequency of the corresponding movie data. Note that the invention is not limited thereto. For example, the amount of data that has been delivered may be stored instead of the distribution frequency 568f, and the amount of data may be added each time the movie data is delivered. The distribution frequency may be calculated based on the amount of the corresponding movie data 568b.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. A game movie distribution method comprising:
acquiring key input information from a game device, the key input information being input by a player using the game device when the player plays a game;
reproducing the game played using the game device by controlling movement of a character object in a three-dimensional virtual space based on the key input information;
setting a game reproduction virtual camera in the three-dimensional virtual space and photographing the three-dimensional virtual space using the virtual camera to generate movie data for distribution, a camera condition of the virtual camera being defined taking account of a view using an external terminal; and
delivering the movie data to the external terminal.

2. The game movie distribution method as defined in claim 1, further comprising:
acquiring specification information that relates to a movie reproduction capability from the external terminal, the specification information including at least an aspect ratio; and
setting an angle of view of the virtual camera based on the specification information.

3. The game movie distribution method as defined in claim 1, further comprising:
setting a focus point in the three-dimensional virtual space based on a position of the character object in the three-dimensional virtual space; and
controlling a position of the virtual camera so that a line-of-sight direction of the virtual camera aims at the focus point.

4. The game movie distribution method as defined in claim 3, further comprising:
setting a virtual damper function that serves as resistance against a change in position of the virtual camera.

5. The game movie distribution method as defined in claim 1, further comprising:
setting a focus point in the three-dimensional virtual space based on a position of the character object in the three-dimensional virtual space; and
controlling rotation of the virtual camera so that a line-of-sight direction of the virtual camera aims at the focus point.

6. The game movie distribution method as defined in claim 5, further comprising:
setting a virtual damper function that serves as resistance against a change in direction of the virtual camera.

7. A game movie distribution system comprising:
a key input acquisition section that acquires key input information from a game device, the key input information being input by a player using the game device when the player plays a game;
a game reproduction section that reproduces the game played using the game device by controlling movement of a character object in a three-dimensional virtual space based on the key input information;
a movie data generation section that sets a game reproduction virtual camera in the three-dimensional virtual space and photographs the three-dimensional virtual space using the virtual camera to generate movie data for distribution, a camera condition of the virtual camera being defined taking account of a view using an external terminal; and
a movie distribution section that delivers the movie data to the external terminal.
